(19) United States
(12) Patent Application Publication
(10) Pub. No.: US 2026/0250862 A1
(43) Pub. Date: Aug. 27, 2026

(54) ELECTROLYTIC CELLS, TREATMENT OF WATER, AND METHODS OF USE

(71) Applicant: Electro-Aeration, Inc., Los Angeles, CA (US)

(72) Inventors: Nicholas ECKELBERRY, Los Angeles, CA (US); Talbott HOWARD, Germantown, TN (US); Yukio AKAGI, Motogo Kawaguchi-City (JP)

(73) Assignee: Electro-Aeration, Inc., Los Angeles, CA (US)

(21) Appl. No.: 19/158,996

(22) PCT Filed: Jul. 5, 2023
(86) PCT No.: PCT/US2023/026912

§ 371 Date: Aug. 22, 2025

Related U.S. Application Data
(60) Provisional application No. 63/358,682, filed on Jul. 6, 2022.

(51) Int. Cl. C25B 11/031; C02F 1/461; C25B 9/65; C25B 9/70; C25B 11/052; C25B 11/063; C25B 11/075; C25B 13/02; C25B 15/06

(52) U.S. Cl. CPC C25B 11/031; C02F 1/46109; C25B 9/65; C25B 9/70; C25B 11/052; C25B 11/063; C25B 11/075; C25B 13/02; C25B 15/06; C02F 2001/46142; C02F 2001/46161; C02F 2307/14

(57) ABSTRACT

The instant disclosure is drawn to electro-catalytic treatment of water using electrolytic cells and reactors comprising the electrolytic cells, and to methods of treating water and using the treated water. The electrolytic cells include: (a) a stack of 3 to 11 alternating cathodic mesh plates and anodic mesh plates stacked one upon another, wherein the alternating cathodic mesh plates and anodic mesh plates face one another, are substantially parallel to one another, and are spaced apart from one another by a separation space; and (b) a conductive titanium cathode rod and a conductive titanium anode rod separately extending through the stack of alternating cathodic mesh plates and anodic mesh plates. A DC power source is applied to the conductive titanium cathode rod and the conductive titanium anode rod to operate the electrolytic cell and carry out electrolysis.

### CROSS-REFERENCE TO RELATED APPLICATIONS

This application is a non-provisional application claiming priority from U.S. 63/358,682, filed Jul. 6, 2022, which is incorporated herein by reference in its entirety.

### FIELD OF THE DISCLOSURE

The instant disclosure is drawn to electro-catalytic treatment of water using electro-catalytic cells and reactors comprising the electro-catalytic cells, and to methods of treating water and using the treated water.

### BACKGROUND

Water makes a good solvent because of its composition of positively and negatively charged molecules that allow it to attract to a variety of substances. With a molecular formula of H₂O, water has a positive electrical charge at the hydrogen atom and a negative electrical charge at the oxygen atom. Water is split into 2 parts hydrogen and 1 part oxygen by electrolysis, generating of hydrogen and oxygen (HHO) gases. Water infused with high concentrations of HHO gases has been referred to as “hydrogen water,” and promoted as having potential health benefits.

Researchers at the Nanjing Agricultural University found that H₂ pretreatment can induce the expression of heme oxygenase (HO-1) gene, one of Alfalfa anti-oxidase gene, and enhance its enzyme activity, reducing the oxidative damage caused by paraquat. They presumed that H₂ might function as an important gaseous molecule that alleviates oxidative stress via HO-1 signaling. They also found that the H₂ pretreatment can improve salt tolerance in rice and Arabidopsis, and the improvement of salt tolerance may be related to the reduction of reactive oxygen species (ROS) injuries in addition, they found that hydrogen enhances the resistance of alfalfa to cadmium and aluminum due to the improvement of alfalfa antioxidant capacity induced by hydrogen.

Seed germination studies showed that H₂ can promote the seed germination rate of winter rye and alfalfa. This finding may promote the application of hydrogen in improving the seed germination rate of plants.

Hydrogen has shown to play a role in regulating flowering time. Roses and other plants change flowering time after treatment of hydrogen water. It was shown that hydrogen can regulate the expression of plant blossom related plant hormone receptor protein gene.

Crop stress resistance can be improved with hydrogen. Drought and salinity stresses often result in crop yield reduction and even death. Studies found that hydrogen water can improve the resistance ability of rice, Arabidopsis and Medicago sativa plants to salinity, drought, and other stresses. The crops irrigation or sprinkler irrigation using hydrogen water will improve the stress resistance of crops, to achieve the purpose of disaster prevention and reduction.

Improvement of crop resistance to disease and pests: The study have found that hydrogen can regulate the expression of receptor protein genes of many plant hormone, including some plant hormones associated with disease resistance, such as salicylic acid and Jasmonic acid (JA) Irrigation of crops by the use of hydrogen water will likely improve crop resistance to pest and disease leading to substitute for pesticides or reduce the use of pesticides thus it protects environment and improve food security.

Reducing fertilizer use: H₂ can regulate the effects of plant hormones such as auxin, cytokine. Hydrogen water treatment can promote the growth of the plant. It has been observed that hydrogen water has a significant effect on the growth of mung bean plants. Therefore, in the future, hydrogen water may be attractively used to irrigate crops, promoting plant growth, and reducing the use of chemical fertilizers.

Due to the security of hydrogen, no poison, no residue, it has a strong advantage of food safety compared with other chemical treatment of fresh agricultural products.”

Progress in the study of biological effects of hydrogen on higher plants and its promising application in agriculture (nih.gov) Authors: Jiqing Zeng: Zhouheng Ye, and Xuejun Sun

[symbol]

“H₂ gas, usually in the form of H₂-saturated water, could play a useful role in improving many aspects of plant growth and productivity, including resistance to stress tolerance, and improved post-harvest durability. Therefore, molecular hydrogen delivery systems should be considered as a valuable addition within agricultural practice. Agriculture and food security are both impacted by plant stresses, whether that is directly from human impact or through climate change. A continuously increasing human population and rising food consumption means that there is need to search for agriculturally useful and environment friendly strategies to ensure future food security. Molecular hydrogen (H₂) research has gained momentum in plant and agricultural science owing to its multifaceted and diverse roles in plants. H₂ application can mitigate against a range of stresses, including salinity, heavy metals, and drought. Therefore, knowing how endogenous, or exogenously applied, H₂ enhances the growth and tolerance against numerous plant stresses will enhance our understanding of how H₂ may be useful for future to agriculture and horticulture. In this review, recent progress, and future implication of H₂ in agriculture is highlighted, focusing on ⁱhow H₂ impacts on plant cell function and how it can be applied for better plant performance. Although the exact molecular action of H₂ in plants remains elusive, this safe and easy to apply treatment should have a future in agricultural practice.

From the these and other studies, there appears to be benefits to large scale application in agriculture from hydrogen enriched water, yet the generation of H₂ water is currently only available at small scale in personal health or household devices. The cost of electricity, use of donating anodes or periodic electrolyte replenishment has precluded the generation of molecular hydrogen on a large scale.

### BRIEF SUMMARY OF THE INVENTION

The instant case is drawn to an energy efficient method for treating water and methods for using the water, for example, to enhance crop yields. Also described are unique electrolytic cells that can be incorporated into electrolytic reactors. The electrolytic cells and reactors can be used to decontaminate wastewater and/or to enrich water with HHO gases. Due to the unique design of the electrolytic cells, they require very little energy to function. For example, a 100-watt solar panel can be used to fully power the electrolytic cells and successfully treat water. Upon connection to DC power, the electrolytic cells generate nano-sized gases bubbles that oxygenate water and lower biochemical oxygen demand (BOD) by proportionally increasing Dissolved Oxygen (DO).

The electrolytic cell includes a stack of 3 to 11 alternating cathodic mesh plates and anodic mesh plates, wherein each mesh plate has an outer perimeter, a center, and a face. The alternating cathodic mesh plates and anodic mesh plates are stacked, one on top of another, like a stack of pancakes. However, unlike a stack of pancakes, each of the mesh plates in the stack are spaced apart from an adjacent mesh plate by a separation space of about 2 to about 100 mm. The stacked orientation and separation space between adjacent mesh plates result in each of the mesh plates being substantially parallel to one another in the stack.

A conductive titanium cathode rod and a conductive titanium anode rod extend perpendicularly through the stack of alternating cathodic mesh plates and anodic mesh plates. The conductive titanium cathode rod and the conductive titanium anode rod are spaced apart from each other but both rods extend through each of the faces of alternating cathodic mesh plates and each of the anodic mesh plates. However, neither rod extends through the center of the stack of mesh plates; and neither rod extends along an outer edge of the stack of mesh plates. Instead, each rod extends through the mesh plates in an area in the mesh plate's faces between the outer perimeter of the mesh plates and the center of the mesh plates. This results in the middle area of each mesh plate to openly face the middle area of an adjacent mesh plates. The conductive titanium cathode rod and the conductive titanium anode rod are typically extend through opposite halves of the faces of the stack of mesh plates.

Typically, an odd number of total mesh plates is used in the stack of mesh plates (3, 5, 7, 9, or 11) because it is preferable to have cathodic mesh plates on each end (top and bottom) of the stack. Flanking with cathodic mesh plates results in two additional electrolyzing zones maximizing both sides of the anodic plates. Therefore, if the stack of mesh plates includes a total of 3 mesh plates, it could include two cathodic mesh plates and one anodic mesh plate sandwiched between the two cathodic mesh plates. Similarly, if the stack of mesh plates includes a total of 5 mesh plates, three of the five mesh plates would be cathodic mesh plates and two of the five mesh plates would be anodic mesh plates. The three cathodic mesh plates for the two ends (top and bottom) of the stack and the third cathodic mesh plate forms the center of the stack of mesh plates. One of the two anodic mesh plates is sandwiched between the bottom cathodic mesh plate and the middle cathodic mesh plate. The other anodic mesh plate is sandwiched between the top cathodic mesh plate and the middle mesh plate. Stacks of 7, 9, and 11 mesh plates are similarly configured having cathodic mesh plates forming the bottom and top of the stack and each of the anodic mesh plates sandwiched between two cathodic mesh plates.

The titanium cathode rod directly contacts and electrically connects to each of the cathodic mesh plates but is not in direct contact and does not directly electrically connect to the anodic mesh plates. For example, holes through which the titanium cathode rod extends through the anodic plates may be bigger holes than the holes through which the titanium cathode rod extends through the cathodic mesh plates. The bigger holes prevent the conductive titanium cathode rod from touching the anodic mesh plates. Similarly, the conductive titanium anode rod directly contacts and electrically connects to each of the anodic mesh plates but is not in direct contact and does not directly electrically connect to the cathodic mesh plates. For example, holes through which the titanium anode rod extends through the cathodic plates may be bigger holes than the holes through which the titanium anode rod extends through the anodic mesh plates. The bigger holes prevent the conductive titanium anode rod from touching the cathodic mesh plates.

A power source is applied to the conductive titanium cathode rod and the conductive titanium anode rod to activate the electrolytic cell. The electricity runs through the conductive titanium cathode rod and the conductive titanium anode rod and extends throughout the stack of alternating cathodic mesh plates and anodic mesh plates, while avoiding a short circuit. A short circuit is avoided using non-conductive spacers between adjacent mesh plates. The non-conductive spacers not only prevent a short circuit but also function to provide the desired spaces between each of the alternating cathodic mesh plates and anodic mesh plates. The arrangement of rods and mesh plates allows for distribution of the current directly from the conductive titanium rods to the mesh plates such that conductance is increased, and resistance (Ω) minimized.

In certain embodiments, the non-conductive spacers are positioned between adjacent faces of the alternating cathodic mesh plates and anodic mesh plates and fitted around the conductive titanium cathode rod and fitted around the conductive titanium anode rod, to prevent a short circuit between adjacent faces of the alternating cathodic mesh plates and anodic mesh plates. For example, the non-conductive spacers may be shaped like a washer. A central hole in the spacers corresponds to the outer circumference of the conductive titanium cathode rod and the outer circumference of the conductive titanium anode rod and extends radially outward from the hole by about 2 mm to about 15 mm, preferably about 2 mm to about 10 mm, about 2 mm to about 8 mm, or about 2 mm to about 5 mm. The diameter of a round non-conductive spacer, including the central hole in the spacer (a spacer in the shape of a washer) is about 5 mm to about 40 mm, preferably about 5 mm to about 35 mm, about 5 mm to about 30 mm, about 5 mm to about 25 mm. The non-conductive spacer has a height substantially identical to the separation space between adjacent faces of a cathodic mesh plate and an anodic mesh plate, i.e., of about 2 mm to about 100 mm, preferably about 2 mm to about 50 mm, more preferably about 2 mm to about 20 mm, about 2 mm to about 10 mm, about 3 mm to about 100 mm, about 3 mm to about 50 mm, about 3 mm to about 20 mm, about 3 mm to about 10 mm, or about 3 mm to about 5 mm.

In various embodiments, the electrolytic cell further comprises one or more bolts running through the stack of alternating cathodic mesh plates and anodic mesh plates. The head of the one or more bolts is positioned outside the exterior face of a terminal cathodic mesh plate at one end (bottom) of the stack and runs through the entirety of the stack extending beyond the exterior face of the terminal cathodic mesh plate at the opposite end (top) of the stack. Nuts are attached to the extending end of the one or more bolts to secure the stack of alternating cathodic mesh plates and anodic mesh plates together.

The conductive titanium cathode rod and the same conductive titanium anode rod can be used to intersect more than one stack of alternating mesh plates. For example, two or more stacks of 3 to 11 alternating cathodic mesh plates can be placed along the same conductive titanium cathode rod and the same conductive titanium anode rod. Typically, when two or more stacks of mesh plates are used along the same set of titanium anode and cathode rods, the stacks of mesh plates are separated by an internal distance from one another by about 4 cm to about 15 cm, preferably about 5 cm to about 12 cm, more preferably about 6 cm to about 12 cm, or about 8 cm to about 10 cm. The set or titanium anode and cathode rods typically extends beyond the last stack of mesh plates along the set of titanium anode and cathode rods on each outer end by an external distance of about 3 cm to about 200 cm. The external distance can vary greatly depending on the number of stacks aligned along the same set of titanium anode and cathode rods. In a preferred embodiment, two stacks are positioned along the same set of the titanium anode and cathode rods. Regardless of the number of stacks along the same set of rods, the external distance is from about 3 cm to about 200 cm, about 5 cm to about 200 cm, about 10 cm to about 200 cm, about 20 cm to about 200 cm, about 30 cm to about 200 cm, about 50 cm to about 200 cm, about 3 cm to about 100 cm, about 5 cm to about 100 cm, about 10 cm to about 100 cm, about 20 cm to about 100 cm, about 30 cm to about 100 cm, or about 50 cm to about 100 cm.

A single electrolytic cell or a series of two or more electrolytic cells arranged along the same set of conductive titanium anode and cathode rod can be used as an aerator. The term “aerator” is used when the stacks of alternating mesh plates are not encompassed in a housing. When the electrolytic cells (stacks) are encased in a housing, the device is referred to as a “reactor” (discussed in more detail later). The electrolytic cells (aerators) can be placed directly in a water supply, for example, in a bucket of water, a tote of water, a barrel of water, a stream, a lake, a pool of water, etc. When power is applied to the electrolytic cells (aerators) submerged in a water supply, power is applied and electrolysis proceeds. For example, one or more individual electrolytic cells (individual aerators) can be submerged into the same body of water or a series of one or more electrolytic cells can submerged into the same body of water. It can be useful to include two or more electrolytic cells of a series of electrolytic cells (stacks of mesh plates) connected by the same set of titanium anode and cathode rods, as described above. A series of electrolytic cells, for example, can be inserted into a hose or piping carrying a water such that the water passes through the stacks of mesh plates as it runs through the hose or piping.

In certain embodiments, the electrolytic cell, or a series of two or more electrolytic cells arranged along the same set of conductive titanium anode and cathode rods, are encased in a housing to form an electrolytic reactor. The housing can have a shape corresponding to the shape of the outer perimeter of the stack of alternating cathodic mesh plates and anodic mesh plates. As one of many different examples, the stack of mesh plates may be circularly shaped (disk-like) and the housing may be a tube shaped component that fits the stack of circularly shaped stack of mesh plates inside. Both ends of the tube-shaped component (top and bottom) typically include end casings as part of the housing. The end casings can be referred to as a top casing and a bottom casing. Typically, the housing in non-conductive. It can be made from plastic, for example polyvinyl chloride (PVC) 40 or 80. The housing and end casings are also typically non-conductive and can also be made from plastic. Preferably, the housing and end casings are manufactured from a non-conductive material, such as polyvinyl chloride.

The electrolytic reactor comprises and one or more inlets for introducing contaminated water into the reactor and one or more outlets for dispensing treated water from the reactor, after treatment. In certain embodiments, an inlet and an outlet are the same structure, i.e., share the same opening into and out of the reactor housing. Contaminated water is introduced into the electrolytic reactor through the opening in the reactor (inlet), is allowed to undergo electrolysis while power is applied to the conductive titanium cathode and anode rods. After electrolysis, the treated water is then discharged from the reactor using the same opening (outlet). This results in a batch-like method for treating water.

In preferred embodiments, however, the one or more inlets and the one or more outlets are separate structures or openings typically oriented on opposite ends of the reactor. The inlet allows contaminated water, or water to be treated, to enter one end of the reactor and the outlet allows water to be discharged or removed from the opposite end of the reactor. The inlet and outlet are placed on opposite ends of the reactor so that water can continuously flow through the electrolytic cell or series of two or more electrolytic cells inside the reactor, which are spaced between the inlet and the outlet. Water to be treated is introduced into the inlet and runs through the one or more stacks of mesh plates inside the reactor. After passing through the one or more stacks of mesh plates, the treated water exits the reactor from the outlet.

Two or more reactors can be connected to one another to form a series of reactors. In a series each reactor is fluidly connected to the other reactors in the series in a sequential manner. The series of reactors can be electrically connected to one another such that all reactors in the series function using the same power source. Alternatively, one or more of the reactors in a series can be independently connected to a power source. For example, each reactor could be individually connected different solar panels. Preferably, the series of reactors are connected to the same power source, which simplifies the process and ensure similar amounts of power is propagated throughout all electrolytic cells within the series of reactors. The series of reactors allow for water to flow sequentially through the two or more reactors. For example, the outlet of a first reactor in the series is fluidly connected to the inlet of the second reactor in the series and the outlet of the second reactor in the series may optionally be connected to the inlet of an additional reactor. This sequential outlet-to-inlet connecting design continues until a desired number of reactors are sequentially connected. The outlet of the terminal reactor in the series serves as the outlet for the entire series. Using a sequentially connected series of reactors allow for water to be treated repeatedly through the consecutive electrolytic cells throughout the series of reactors. The number of reactors to be included in the series can be determined by the quality of the water to be treated and the desired amount of HHO in the treated water. For example, highly contaminated water can be run through a longer series of reactors to ensure complete purification. It should be noted that water flow rate can also be adjusted to control the treatment process. A slower water flow rate through the one or more reactors results in the water being housed inside the one or more reactors for a longer period for reaction with the one or more electrolytic cells.

A series of sequentially connected reactors can be placed in a module, which is a container or a container-like structure. For example, a series of four sequentially connected reactors can conveniently be placed into a module and the module transported to and placed near water to be treated. A series of four sequentially connected reactors can be referred to as a “quad reactor,” even though it contains four individual reactors (forming the “quad”). The four individual reactors of the quad reactor can be oriented such that the flow through each consecutive reactor alternates. The inlet end of one reactor forms a bottom of the quad reactor and the outlet end of the one reactor forms a top of the quad reactor. The second reactor in the quad reactor is inverted, such that inlet end of the second reactor forms a top of the quad reactor and the outlet end of the second reactor forms a bottom of the quad reactor. The third and fourth reactors are similarly consecutively fluidly connected to the first and second reactor of the quad, each inverted related to the next. Orienting the four reactors in this manner minimizes the distance between the outlet of one individual reactor to the intel of a subsequent individual reactor, which are fluidly connected. It also minimized the overall size of the quad reactor. In other embodiments, however, the four sequential reactors (or any number of sequential reactors) can be connected in-line, meaning that alternating inversion of consecutive reactors is not needed. An in-line arrangement can be useful where the reactors serve to treat the water while simultaneously acting as piping to transport the water to a different location.

Placing a series of reactors, such as a quad reactor, into a module allows for simpler transportation of the series of reactors. It also allows for the series of reactors to be connected and arranged in the module at a convenient location away from the water to be treated. After manufacture, the module is transported to the water to be treated to treat the water.

A module may have an open top or other type of openings, such as a module inlet and module outlet, allowing for water to be treated to enter and exit the module. Like a series of sequentially connected reactors, two or more modules can also be sequentially and fluidly connected such that water from a first module, after treatment through the series of reactors in the first module, flows to a second module for treatment with a series of reactors positioned in the second module. The sequential connection of modules can continue until a desired number of modules is reached.

Water to be treated enters the inlet of the first reactor in the series in a module, for example, the water can be piped to the inlet of the first reactor in the series. The piping can enter the module through an open top area of the module or through a side of the module. The outlet of the last reactor in the series can be open such that the treated water flows directly from the outlet into the area inside the module and around the series of reactors. If the outlet of the last reactor is oriented in a top area of the module, as water is treated and expelled from the outlet, the module will fill with treated water. The treated water can continue to fill the module so the reactors inside the module become submerged in the treated water or until the water reaches the height of the outlet expelling the water into the module. Upon reaching a threshold level (a predetermined height inside the module), the water can be allowed to flow into a subsequent or adjacent module. The subsequent or adjacent module can function opposite the first module. As the subsequent or adjacent module receives the water, the subsequent or adjacent module fills with water. The inlet to the first reactors in the series of rectors in the subsequent or adjacent module is at the top off the module. Therefore, upon the water filling the module and reaching the height of the inlet at the top of the module, the water will enter in intel. The number of sequentially connected modules is not limited and the sequence can be connected in a variety of different ways.

One or more modules or a series of two or more sequentially connected modules can be placed into a tank. The water is passed through the reactors in the one or more modules, treated by the electrolytic cells, and expelled from the one or more modules. The tank can include water to be treated by the modules or can fill with treated water after treatment through the reactors. Preferably, the water is expelled into a separate holding tank for treated water. As the water to be treated is run through the reactors of the modules and expelled, the amount of water in the tank holding the one or more modules decreases. Water to be treated can be continuously added to the tank. Alternatively, the tank of water to be treated can be processed in a batch. In a batch system, after a first batch of water to be treated as been run through the series of reactors in the one or more modules, the treated water exits the tank. The tank is then refilled with a new batch of water to be treated.

The electrolytic cells, the electrolytic reactors, and series of reactors including series of reactor inside of modules are useful in methods for treating water, for example, to hydrogenate and oxygenate water. The treated water is useful in methods for growing crops, increasing crop yields, reducing (or eliminating) reliance on herbicides and/or pesticides, and expediting germination of seeds.

### BRIEF DESCRIPTION OF FIGURES

Implementation of the present technology will now be described, by way of example only, with reference to the attached figures, wherein:

FIG. 1 shows an electrolytic cell comprising a stack (10) of five alternating cathodic mesh plates (1) and anodic mesh plates (2) intersected with two titanium rods (3) serving as a cathode and an anode.

FIG. 2 shows a combination of two electrolytic cells intersected with the same two titanium rods (3) serving as a cathode and an anode.

FIG. 3 shows four housed reactors (14) connected in a series, having an inlet (16) and an outlet (17).

FIG. 4 shows the inside construction of the four housed reactors of FIG. 3, connected in a series, wherein each reactor contains a combination of two electrolytic cells intersected with the same two titanium rods (3) serving as a cathode and an anode.

FIG. 5(a) is a perspective view of a tank (22) containing five modules (20) containing four housed reactors (14) connected in a series.

FIG. 5(b) is a front view of a tank (22) with five modules (20), each containing four housed reactors (14) connected in a series.

FIG. 5(c) is a top view of a tank (22) with five modules (20), each containing four housed reactors (14) connected in a series.

FIG. 5(d) is a side view of a tank (22) with five modules (20), each containing four housed reactors (14) connected in a series.

FIG. 6 is a diagram outlining an electro-catalytic water purification process using a reactor (14).

FIG. 7 is a table showing the results of field testing on rice patties using water treated in accordance with the instant disclosure compared to control.

### DETAILED DESCRIPTION OF THE INVENTION

Water electrolysis is a process using a direct current to split water molecules (H₂O) into oxygen (O₂) and hydrogen (H₂). The process can be carried out in an electrolyzer. Conventional electrolyzers are fitted with two electrodes connected internally via an electrolyte in water and externally connected to a power supply. The electrolytic cells and reactors of the instant disclosure are unique in their design and function using a surprisingly low amount of power, i.e., they are very energy efficient. The unique design and arrangements of the electrolytic cells and electrolytic reactors containing the cells results in an increase in conductance and reduction of resistance (Ω). Electrolysis can be carried out without requiring the addition of solutes, without requiring adjustments to pH, and without requiring other modifications to water before electrolysis (such as the addition of surfactants or other materials not already present in the water to be treated). In other words, the electrolytic cells and reactors are useful for treating water “as-is” regardless of whether the water is contaminated water, ocean water, lake water, etc.

The technology described in the instant disclosure is drawn to electrolytic cells, electrolytic aerators comprising the cells, and electrolytic reactors containing the cells. The electrolytic cells and aerators or reactors incorporating the cells can be deployed to generate hydrogen and oxygen gases (HHO gases) in-situ with little regard for the conductivity of the water, allowing for the generation of beneficial sub-micron gases in water for use in agriculture.

In water splitting, a hydrogen-containing species is reduced to form gaseous hydrogen in an electrode reaction called hydrogen evolution reaction (HER). At the anode, an oxygen-containing species is oxidized to gaseous oxygen in the so-called oxygen evolution reaction (OER). Protons are the main charge carrier that diffuse from the anode to the cathode via a highly effective bond shift mechanism. Protons are reduced to hydrogen in the HER by recombination of two hydrogen atoms at the cathode. The OER occurs at the anode and consists of several reaction steps which generate a set of reactive oxygen species or ROS which include, H₂O₂, O³, O, and ·OH. If NaCl or other chloride is present in water, the salt will be dissociated and produce chlorine species.

The following anode and cathode reactions are typical of an electrode pair:

| Anode Reactions | Cathode reactions |
|---|---|
| a) 2Cl— = Cl₂ + 2e− | a) 2 H+ + 2e− = H₂ |
| b) H₂O = ½ O₂ + 2H+ + 2e− | b) 2 H₂O + 2e− = H₂ + 20H— |
| c) 2 H₂O = 2 HO₂ + 2 H+ + 2e− | c) H₂0 + O2 + 2e− = HO⁻ 2OH— |
| d) 3 H₂O = O3 + 6 H+ + 6e− | d) Cl₂ + 2e− = 2Cl— |

The following chemical reactions may occur between an anode and a cathode electrode pair when solutes such as sodium chloride (NaCl) are present in the water.

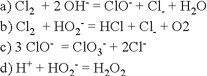

In electrochemistry, overpotential is the potential difference (voltage) between a half-reaction's thermodynamically determined reduction potential and the potential at which the redox event is experimentally observed. The term is directly related to a cell's voltage efficiency. In an electrolytic cell the existence of overpotential implies the cell requires more energy than thermodynamically expected to drive a reaction. In a galvanic cell the existence of overpotential means less energy is recovered than thermodynamics predicts. In each case the extra/missing energy is lost as heat. Avoiding overpotential and over-voltage in electrolysis is critical as these are indications of poor design that can result in excessive and hazardous heat and failure to achieve desired chemical reactions. The electrolytic cells of the instant disclosure avoid overpotential and excessive heating while achieving gas evolution using very little energy. The electrolytic cells avoid over-potential and over-current due in part to the complete distribution of current throughout the stack of mesh plates and the conductive titanium cathode and anode rods.

The electrolytic cells complete use of the electricity is such that an individual can safely reach into water while it is being treated with the electrolytic cells without being hurt or electrocuted. Therefore, use of the electrolytic cells in nature does not pose a threat to wildlife. The electrolytic cells can function at a current of 12- and 13 volts with 10-50 amperes or 300-700 watts. The electrolytic cells can be used in all types of water, for example, the electrolytic cells can be used with seawater with a conductivity of 50 mS/cm or can be used with drinking water (having conductivity of 200 μS/cm to 800 μS/cm). The cells can even be used with water having ultra-low conductivity, for example, water recovered using a Reverse Osmosis solute (having conductivity of 0.05 μS/cm-200 μS/cm). The electrolytic cells of the instant disclosure can be used in all types of water without altering its design. This allows for widespread use of the technology in varying types of environments. The operational range of the electrolytic cells allow for use in areas where conductivity fluctuates, sometimes greatly, for example, in crop growing areas where dissolved solids (and therefore conductivity) will vary.

An electrolytic cell according to the instant disclosure includes a stack of 3 to 11 alternating cathodic mesh plates and anodic mesh plates stacked one upon another, each of the alternating cathodic mesh plates and anodic mesh plates having an outer perimeter, a center, and a face. In a preferred embodiment, an electrolytic cell includes 5 alternative cathodic mesh plates and anodic mesh plates, wherein 3 of the 5 mesh plates are cathodic mesh plates and 2 of the five mesh plates are anodic mesh plates. The alternating cathodic mesh plates and anodic mesh plates face one another, are substantially parallel to one another, and are spaced apart from one another by a separation space. The electrolytic cell further includes a conductive titanium cathode rod and a conductive titanium anode rod separately extending through each of the cathodic mesh plates and each of the anodic mesh plates of the stack. The conductive titanium cathode rod and the conductive titanium anode rod extend through the face of each mesh plate in an area between the outer perimeter and the center of each mesh plate.

The cathodic mesh plates are typically formed from titanium. Preferably, the cathodic mesh plates are formed from uncoated titanium. In other words, the cathodic mesh plates preferably are not coated with a metal oxide, such as iridium oxide, platinum oxide, ruthenium oxide, or a combination thereof. The cathodic mesh plates are planar structures having a porous face. The shape of the planes is not limited. Typically, the shape of the planes is circular or round, but the shape can be square, square, rectangular, triangular, diamond, oblong, etc. The diameter of the cathodic mesh plates can vary. However, in certain embodiments, circular cathodic mesh plates have a diameter of about 8 cm to about 30 cm, preferably about 10 cm to about 30 cm, about 10 cm to about 25 cm, about 10 cm to about 20 cm, about 10 cm to about 15 cm, about 12 cm to about 30 cm, about 12 cm to about 25 cm, about 12 cm to about 20 cm, about 12 cm to about 25 cm, about 12 cm to about 20 cm, or about 12 cm to about 18 cm.

The thickness of the cathodic mesh plates can vary. Nonetheless, in certain embodiments, the thickness of the cathodic mesh plates is about 1 mm to about 10 mm. Preferably the thickness of the cathodic mesh plates is about 1 mm to about 8 mm, about 1 mm to about 6 mm, about 1 mm to about 5 mm, about 1 mm to about 4 mm, about 2 mm to about 10 mm, about 2 mm to about 8 mm, about 2 mm to about 6 mm, about 2 mm to about 5 mm, or about 2 mm to about 4 mm.

The anodic mesh plates are also typically formed from titanium. However, the anodic mesh plates are preferably coated with a metal oxide coating. For example, the anodic mesh plates can be electrostatically coated with iridium oxide, platinum oxide, ruthenium oxide, or a combination thereof. Preferably, the anodic mesh plates are coated with iridium oxide (IrO₂) and ruthenium oxide (RuO₂). Preferably, the anode coating further comprises platinum oxide (PtO₂) and/or palladium (II) oxide (PdO). For example, in certain embodiments, the anodic mesh plate is coated with a metal oxide coating comprising from 60 to 90 wt % ruthenium oxide (RuO₂), for example from 70 to 85 wt % ruthenium oxide (RuO₂). Preferably, the metal oxide coating also comprises from 10 to 40 wt % iridium oxide (IrO₂), for example 15 to 30 wt % iridium oxide (IrO₂). In preferred embodiments, oxidized metals such as Ru blended with Ir, and in some cases, PtO₂, are used for increased durability.

The anodic mesh plates are planar structures having a porous face. The shape of the planes is not limited. Typically, the shape of the planes is circular or round, but the shape can be square, square, rectangular, triangular, diamond, oblong, etc. The diameter of the cathodic mesh plates can vary. However, in certain embodiments, circular anodic mesh plates have a diameter of about 8 cm to about 30 cm, preferably about 10 cm to about 30 cm, about 10 cm to about 25 cm, about 10 cm to about 20 cm, about 10 cm to about 15 cm, about 12 cm to about 30 cm, about 12 cm to about 25 cm, about 12 cm to about 20 cm, about 12 cm to about 25 cm, about 12 cm to about 20 cm, or about 12 cm to about 18 cm.

The thickness of the anodic mesh plates can vary. Nonetheless, in certain embodiments, the thickness of the anodic mesh plates is about 1 mm to about 10 mm. Preferably the thickness of the cathodic mesh plates is about 1 mm to about 8 mm, about 1 mm to about 6 mm, about 1 mm to about 5 mm, about 1 mm to about 4 mm, about 2 mm to about 10 mm, about 2 mm to about 8 mm, about 2 mm to about 6 mm, about 2 mm to about 5 mm, or about 2 mm to about 4 mm.

The titanium mesh forming the cathodic mesh plates and the anodic mesh plates can be in a variety of different forms. For example, the titanium mesh metal plates may be made from expanded wire mesh, weaved wire mesh, welded wire mesh, a wire cloth, perforated plates, sintered metal fibers, sintered metal powder, or any other perforated configuration that allows water to pass through. The apertures in the mesh may have any suitable shape, but preferably the apertures have the shape of a rhomb, square, rectangle, trapezium, circle or the like. The dimensions (e.g. the sides of a rhomb) of the apertures suitably range from about 0.5 to about 50, preferably from about 0.5 to about 15 or 0.5 to 5 mm. Each aperture preferably has an area from about 0.01 to about 2500, more preferably from about 0.2 to about 500, and most preferably from about 1 to about 100 mm².

The conductive titanium cathode rod, as its name suggests, is made from titanium. Preferably, the conductive titanium cathode rod is formed from uncoated titanium. In other words, the conductive titanium cathode rod preferably is not coated with a metal oxide, such as iridium oxide, platinum oxide, ruthenium oxide, or a combination thereof. The conductive titanium cathode rod can be a variety of different shapes, lengths, and sizes. For example, the conductive titanium cathode rod can be a square shaped rod, an octagonal shaped rod, a triangular shaped rod, a round shaped rod, and the like. In a preferred embodiment, the conductive titanium cathode rod is round. In certain embodiments, the diameter of the rod is from about 3 mm to about 50 mm, preferably about 5 mm to about 30 mm, more preferably about 5 mm to about 20 mm. In any event, the diameter of the conductive titanium cathode rod is essentially the same diameter as a smaller hole in the face of each of the alternating mesh plates. This allows for the conductive titanium cathode rod to be in electrical contact with the cathodic mesh plates at the interface around the smaller hole and the perimeters of the conductive titanium cathode rod.

The conductive titanium anode rod, as its name suggests, is made from titanium. Preferably, the conductive titanium anode rod is formed from uncoated titanium. In other words, the conductive titanium anode rod preferably is not coated with a metal oxide, such as iridium oxide, platinum oxide, ruthenium oxide, or a combination thereof. For example, the conductive titanium anode rod can be a square shaped rod, an octagonal shaped rod, a triangular shaped rod, a round shaped rod, and the like. In a preferred embodiment, the conductive titanium cathode rod is round. In certain embodiments, the diameter of the rod is from about 3 mm to about 50 mm, preferably about 5 mm to about 30 mm, more preferably about 5 mm to about 20 mm. In any event, the diameter of the conductive titanium cathode rod is essentially the same diameter as a smaller hole in the face of each of the alternating mesh plates. This allows for the conductive titanium cathode rod to be in electrical contact with the cathodic mesh plates at the interface around the smaller hole and the perimeters of the conductive titanium cathode rod.

In certain embodiments, the conductive titanium cathode rod and a conductive titanium anode rod are generally the same shape, diameter, and length.

The separation space between adjacent mesh plates is typically about 2 mm to about 100 mm. Nonetheless, in certain embodiments, the separation space between adjacent mesh plates is about 2 mm to about 50 mm, about 2 mm to about 50 mm, about 2 mm to about 20 mm, about 2 mm to about 10 mm, about 2 mm to about 5 mm, about 3 mm to about 100 mm, about 3 mm to about 50 mm, about 3 mm to about 20 mm, about 3 mm to about 10 mm, about 3 mm to about 5 mm, about 2 mm, about 3 mm, about 4 mm, or about 5 mm. The separation space between adjacent mesh plates can be essentially the same between each adjacent mesh plate of the stack.

The conductive titanium cathode rod and a conductive titanium anode rod extend perpendicularly through the stack of alternating cathodic mesh plates and anodic mesh plates. The conductive titanium cathode rod and the conductive titanium anode rod are spaced apart from each other but both rods extend through each of the faces of alternating cathodic mesh plates and each of the anodic mesh plates. However, neither rod extends through the center of the stack of mesh plates; and neither rod extends along an outer edge of the stack of mesh plates. Instead, each rod extends through the mesh plates in an area in the faces of the mesh plates between the outer perimeter of the mesh plates and the center of the mesh plates. This results in the middle area of each mesh plate to openly face the middle area of adjacent mesh plates. The conductive titanium cathode rod and the conductive titanium anode rod typically extend through opposite halves of the faces of the stack of mesh plates.

A typical distance between the centers of the conductive titanium cathode rod and the conductive titanium anode rod is about 4 cm to about 15 cm. Preferably, the distance between the centers of the conductive titanium cathode rod and the conductive titanium anode rod is about 4 cm to about 12 cm, about 4 cm to about 10 cm, about 5 cm to about 15 cm, about 5 cm to about 12 cm, about 5 cm to about 10 cm, about 8 com to about 15 cm, or about 8 cm to about 12 cm.

Preferably, an odd number of total mesh plates is used in the stack of mesh plates (3, 5, 7, 9, or 11) to allow for cathodic mesh plates to be position on each end (top and bottom) of the stack. This makes use of both sides of the anodic mesh plates. Therefore, if the stack of mesh plates includes a total of 3 mesh plates, it could include two cathodic mesh plates and one anodic mesh plate sandwiched between the two cathodic mesh plates. Similarly, if the stack of mesh plates includes a total of 5 mesh plates, which is preferred, three of the five mesh plates are cathodic mesh plates and two of the five mesh plates are anodic mesh plates. The three cathodic mesh plates form the two ends (top and bottom) of the stack and the third cathodic mesh plate forms the center of the stack of mesh plates. One of the two anodic mesh plates is sandwiched between the bottom cathodic mesh plate and the middle cathodic mesh plate. The other anodic mesh plate is sandwiched between the top cathodic mesh plate and the middle mesh plate. Stacks of 7, 9, and 11 mesh plates are similarly configured having cathodic mesh plates forming the ends (bottom and top) of the stack and each of the anodic mesh plates sandwiched between two cathodic mesh plates. In a preferred embodiment, the alternating stack of mesh plates includes 5 mesh plates.

The titanium cathode rod directly contacts and electrically connects to each of the cathodic mesh plates but is not in direct contact and does not directly electrically connect to the anodic mesh plates. For example, holes through which the titanium cathode rod extends through the anodic plates may be bigger holes than the holes through which the titanium cathode rod extends through the cathodic mesh plates. The bigger holes are sized to prevent the conductive titanium cathode rod from touching the anodic mesh plates. Similarly, the conductive titanium anode rod directly contacts and electrically connects to each of the anodic mesh plates but is not in direct contact and does not directly electrically connect to the cathodic mesh plates. For example, the holes through which the titanium anode rod extends through the cathodic plates may be bigger holes than the holes through which the titanium anode rod extends through the anodic mesh plates. The bigger holes are sized to prevent the conductive titanium anode rod from touching the cathodic mesh plates.

The use of bigger and smaller holes in the stack of mesh plates results in each mesh plate including one smaller big hole (for contacting the conductive titanium anode rod or cathode rod) and one bigger hole sized to prevent contact with the conductive titanium anode rod or cathode rod). The alternating mesh plates of the stack are oriented such that the smaller hole of one mesh plate is adjacent to the larger hole of the adjacent mesh plates. The allows for the conductive titanium cathode rod to connect to each of the cathodic mesh plates via the smaller holes in the cathodic mesh plates while extending through the larger holes in the anodic mesh plates while avoiding contact with the anodic mesh plates. Similarly, the conductive titanium anode rod connects to each of the anodic mesh plates via the smaller holes in the anodic mesh plates while extending through the larger holes in the cathodic mesh plates while avoiding contact with the cathodic mesh plates.

A power source is applied to the conductive titanium cathode rod and the conductive titanium anode rod to activate one or more electrolytic cells. The electricity runs through the conductive titanium cathode rod and the conductive titanium anode rod and extends throughout the entirety of the stack of alternating cathodic mesh plates and anodic mesh plates, while avoiding a short circuit. A short circuit is avoided using non-conductive spacers between adjacent mesh plates. The non-conductive spacers not only prevent a short circuit but also function to provide the desired spaces between each of the alternating cathodic mesh plates and anodic mesh plates. The arrangement of rods and mesh plates allows for distribution of the current directly from the conductive titanium rods to the mesh plates such that conductance is increased, and resistance (Ω) minimized.

In certain embodiments, the non-conductive spacers are positioned around the conductive titanium rods to prevent a short circuit between adjacent faces of the alternating cathodic mesh plates and anodic mesh plates. For example, the non-conductive spacers may be shaped like a washer. A central hole in the spacers corresponds to the outer circumference of the conductive titanium cathode rod and the outer circumference of the conductive titanium anode rod and extends radially outward from the hole in their center by about 1 mm to about 30 50 mm. The size of the spacer matches the gap between plates so as to eliminate short circuits The diameter of the non-conductive spacers, including the hole in the center of the spacers, is about 0.5 cm to about 3 cm, about 0.5 cm, to about 2 cm, or about 1 cm to about 3 cm. The spacer has a height substantially identical to the separation space between adjacent faces of a cathodic mesh plate and an anodic mesh plate.

Nonlimiting examples of non-conductive material that can be used for the non-conductive spacer include ceramic materials, a polymeric materials, or a polymer material selected from polypropylene, polyethylene, cellophane, cellulose, methylcellulose, rayon, nylon, or a combination thereof.

In various embodiments, the electrolytic cell further comprises one or more bolts running through the stack of alternating cathodic mesh plates and anodic mesh plates. The head of the one or more bolts is positioned outside the exterior face of a terminal cathodic mesh plate at one end (bottom) of the stack and runs through the entirety of the stack extending beyond the exterior face of the terminal cathodic mesh plate at the opposite end (top) of the stack. Nuts are attached to the extending end of the one or more bolts to secure the stack of alternating cathodic mesh plates and anodic mesh plates together. One or more internal washers/spacers can be placed between the head of the bolt and the nut. For example, washer/spacers can be between each mesh plate. Furthermore, washer/spacers can be placed between the head of the bolt and the outer facing face of the terminal (bottom) cathodic mesh plate. Similarly, a washer/spacer can be placed between the nut and the outer facing face of the terminal (top) cathodic mesh plate. The bolts, nuts, and washer are typically metal bolts, nuts, and washers. In certain embodiments, it is preferable that the bolts, nuts, and washers are made from titanium.

The same conductive titanium cathode rod and the same conductive titanium anode rod can be used to intersect more than one stack of alternating mesh plates. For example, two or more stacks of 3 to 11 alternating cathodic mesh plates can be placed along the same conductive titanium cathode rod and the same conductive titanium anode rod. Typically, when two or more stacks of mesh plates are used along the same set of titanium rods, the stacks of mesh plates are separated by an internal distance of about 25 to about 200 cm. The set or titanium rods typically extends beyond the last stack of mesh plates on each outer end by an external distance of about 25 to about 200 cm. In certain embodiments, the set of titanium rods extend beyond the stack of mesh plates on each outer end by an external distance of about 25 cm to about 150 cm, about 25 cm to about 125 cm, about 25 cm to about 110 cm, 50 to about 200 cm, about 50 to about 150 cm, about 50 to about 125 cm, about 50 to about 110 cm, about 75 to about 200 cm, about 75 to about 150 cm, about 75 to about 125 cm, or about 75 to about 110 cm.

A single electrolytic cell or a series of two or more electrolytic cells arranged along the same set of conductive titanium rods can be used as an aerator. For example, the electrolytic cells can be placed in a water supply. When power is applied to the electrolytic cells submerged in a water supply, electrolysis proceeds. The aerator can be submerged in a bucket of water, a tote of water, a tank of water, a body of water (e.g., a lake, a pond, a swimming pool), etc., and used to aerate the water.

In certain embodiments, the electrolytic cell, or a series of two or more electrolytic cells arranged along the same set of conductive titanium rods are encased by a housing to form an electrolytic reactor. The housing can have a shape corresponding to the shape of the outer perimeter of the stack of alternating cathodic mesh plates and anodic mesh plates. As one of many different examples, the stack of mesh plates may be circularly shaped (disk-like) and the housing may include a tube-shaped component that fits the stack of circularly shaped stack of mesh plates, inside the tube-shaped housing component. Both ends of the tube-shaped housing component (top and bottom) can include end casings as parts of the housing. The end casings can be referred to as a top casing and a bottom casing. The inside diameter of the tube-shaped housing component typically has a diameter substantially similar or substantially identical to the outer perimeter of the one or more stacks of circular mesh plates (in an embodiment wherein the mesh plates are circularly shaped). Substantially all or most of the water flow is captured and directed through the faces of the alternating mesh plates by abutting the outer perimeter of the mesh plates against the inside of the housing component (such as a tube-shaped housing component) to the outer perimeter of the mesh plates. The housing containing the one or more electrolytic cells is preferably made from a non-conductive durable material, for example, a plastic. Nonlimiting examples of useful plastics include polyvinyl chloride (PVC) 40 and 80. The outer perimeter of the alternating mesh plates fits snuggly inside the housing and does not cause a short circuit because the housing is non-conductive.

The electrolytic reactor comprises one or more inlets for introducing contaminated water into the reactor and one or more outlets for dispensing treated water from the reactor, after treatment. In certain embodiments, the inlet and outlet are the same structure or opening. Contaminated water is introduced into the electrolytic reactor through an opening in the reactor (inlet) and allowed to undergo electrolysis while power is applied to the conductive titanium cathode rod and the conductive titanium anode rod of the reactor. After electrolysis, the treated water can then be discharged from the reactor using the same opening (outlet). In some instances, however, it is preferable that inlets and outlets are separate structures or opening, for example, on opposite ends of the reactor. An inlet allows contaminated water, or water to be treated, to enter the reactor and a separate outlet allows water to be discharged or removed from the reactor. In this arrangement, an inlet and an outlet are placed on opposite ends of the reactor such that the electrolytic cell or series of two or more electrolytic cells is between the inlet and the outlet. Water to be treated is introduced into the inlet and runs through the one or more stacks of mesh plates inside the reactor. After passing through the one or more stacks of mesh plates, the treated water exits the reactor from an outlet.

Two or more reactors can be connected to one another to form a series of electrolytic reactors. In a series, each reactor is fluidly connected to the other reactors in a sequential manner. The series of reactors can be electrically connected to one another such that all reactors in the series function using the same power source or one or more reactors in the series can be connected to a different power source. For example, each reactor could be individually connected different solar panels. The series of reactors allow for water to flow sequentially through two or more reactors for treatment. For example, the outlet of a first reactor in the series may be fluidly connected to the inlet of the second reactor in the series and the outlet of the second reactor in the series may optionally be connected to the inlet of an additional reactor. This sequential outlet-to-inlet connecting process can continue until a desired number of reactors are sequentially connected. The outlet of the terminal reactor in the series can serve as the outlet for the entire series.

A series of sequentially connected reactors can be placed in a module, which is a container or a container-like structure. The shape of the module is not critical, but the module can conveniently be a box-like structure. A series of four sequentially connected reactors can be placed into a single module and the module transported to and/or placed near water to be treated by the series of reactors inside the module. The modules may have an open top or other type of opening allowing for water to be treated to enter the module. Like a series of sequentially connected reactors, two or more modules can also be sequentially connected such that water from a first module, after treatment through the series of reactors in the first module, flows to a second module for treatment with a series of reactors positioned in the second module. The sequential connection of modules can continue until a desired number of modules is reached.

One or more modules or a series of two or more modules that are sequentially connected can be placed into a tank. The tank can include water to be treated by the modules. The water is passed through the reactors in the one or more modules, treated by the electrolytic cells, and expelled from the one or more modules. Preferably, the water is expelled into a separate holding tank for treated water. As the water to be treated is run through the reactors of the one or more modules and expelled, the amount of water in the tank holding the one or more modules decreases. Water to be treated can be continuously added to the tank or the water to be treated can be processed in batches. In a batch system, after a first batch of water to be treated as been run through the series of reactors in the one or more modules, the treated water exits the tank. After all the water in the tank has been treated and removed, the can be re-filled and the process repeated.

The electrolytic cells, the electrolytic reactors, and series of reactors including series of reactor inside of modules are useful in methods for decontaminating water. The electrolytic cells, the electrolytic reactors, and series of reactors including series of reactor inside of modules are useful in methods for treating water, for example, to hydrogenate and oxygenate water. The treated water is useful in methods for growing crops, increasing crop yields, reducing (or eliminating) reliance on herbicides and/or pesticides, and expediting germination of seeds.

This generation of water's constituent gases (H₂ and O₂) now at a nano-sized level appears as gaseous in the water. These micron and nano sized gases composed of elemental hydrogen and oxygen in solution have inherent properties which can be used for plant growth enhancement, root-rot mitigation, and pest disinfection, for example, by spraying foliage.

The production of HHO gases through electrocatalytic reaction engenders chemical reactions with other compounds such as carbon dioxide, which gain electrons through reduction, potentially transforming the inorganic compound to an organic weak acid such as formic acid or other simple organic compounds. At the anode, or positive side, the generated reactive oxygen species can oxidize chlorides by breaking salt bonds such as NaCl.

In certain embodiments, one or more electrolytic cells or aerators according to the instant disclosure are placed within a water tote with irrigation water to be used in the field or aquaponics. A solar generated DC voltage, for example, from one or more solar panels, is applied to the one or more electrolytic cells and the HHO enriched water is immediately generated and ready for use, as monitored by a drop of oxygen reduction potential (ORP) from a positive to a negative value. One or more electrolytic cells, aerators, or reactors can be positioned within a water flow to a garden, or growing area, and powered by solar panels.

If the one or more electrolytic cells, aerators, or reactors are used in brackish or sea water, they can be used to generate chlorine species for disinfection or used to remove algae, such as red tides. Other uses include the following: increased water adsorption through nano-configuration of water, lowering effluent contamination through increased dissolved oxygen, lowered bacterial contaminants, reduction of nitrogen compounds, oil and grease dewatering, remediation of petrochemical contaminated waters, pool cleaning system for lower chemical use, HHO baths (healing), HHO water for food bacterial decontamination (vegetables and meats), cooling tower decontamination of wholesale drinking water, bars and hotels, water decontamination for rice paddy flooding or hydroponics, growth enhancement in cannabis and other flowering industries. The electrolytic cells and reactors are useful in areas where lowering of organic pollutants is desired.

In certain embodiments, the electrolytic cells can be used for electrochemical reduction of carbon dioxide or the conversion of carbon dioxide (CO₂) to more reduced chemical species using electrical energy. Electrochemical reduction of carbon dioxide represents a possible means of converting carbon dioxide (CO₂) to organic feedstocks such as formic acid (HCOOH), carbon monoxide (CO), methane (CH₄), ethylene (C₂H₄) and ethanol (C₂H₅OH) which can then be oxidized along with the carbonic acid. CO₂+2 H⁺+2 e⁻→HCOOH (formic acid) Electro potential (−0.061 volt). The redox potentials for these reactions are similar to the reactors for hydrogen evolution in aqueous electrolytes. Thus, electrochemical reduction of CO₂ is usually competitive with hydrogen evolution reactions.

While there are many other applications to a technology that generates HHO gases in solution at micron and nano-sized gaseous states, it is understood by those that become familiar with the art that the construct and geometry of the electrolytic cells and reactors of the instant disclosure exhibit low resistance for maximum electron generated water dissociation.

### Example 1

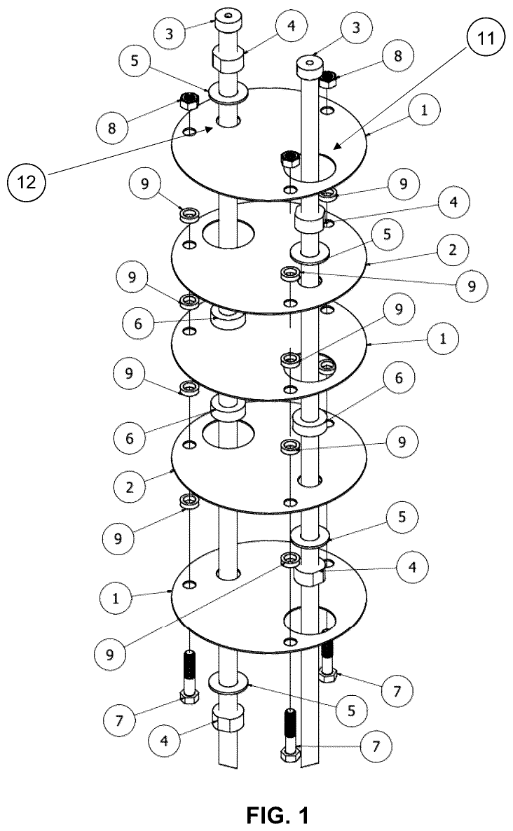

A field study was carried out on Dec. 15, 2021, to test treatment of raw wastewater from the Pleasant Ridge Trailer Lagoon, located at 6514 Pleasant Ridge Road, TN 38053. A General Permit was procured from the United States Environmental Protection Agency (EPA); Permit TN 067482. Wastewater was treated with an electrolytic cell like depicted in FIG. 1 having a stack of 5 alternating cathodic mesh plates and anodic mesh plates. The electrolytic cell was powered by a solar panel providing between 250 and 400 Watts of energy. The electrolytic cell was submerged into a 5-gallon, plastic bucket filled with tap water and electrolysis was carried out for 6 minutes. Samples of the treated water were sent to the Environmental Engineering Laboratory, at Christian Brothers University, 650 E. Parkway South, Memphis. The results are presented in the table below.

| | | | | |
|---|---|---|---|---|
| TSS | 175 | 100 | Reduction: | −43% |
| Dissolved Oxygen | 2.5 | 8.1 | Increase | +225% |
| BOD | 15 | 10 | Decrease: | −34% |
| COD | 249 | 135 | Decrease: | −46% |
| NH³ | 06 | 0.03 | Decrease: | −50% |
| TKN | 1.2 | 0.02 | Decrease | −84% |
| NO⁻₂ | 0.02 | 0.02 | No Change | 00% |
| PO₄³⁻ | 2.5 | 2.5 | No change | 00% |

The data show a significant increase in dissolved oxygen (DO) and a reduction of total suspended solids (TSS), biochemical oxygen demand (BOD), chemical oxygen demand (COD), ammonia (NH₃), and Kjeldahl nitrogen (TKN). It was also observed that treatment of the water produced a significant amount of hydrogen peroxide, which is a useful disinfectant preventing or treating mold or fungal infections, especially when used on foliage as a spray.

### Example 2

In March of 2022, a study was carried on in Somis, CA to determine how water treated with the electrolytic cells of the instant case influences the growth and development of tomato plants. An electrolytic cell like depicted in FIG. 1 having a stack of 5 alternating cathodic mesh plates and anodic mesh plates was placed in a 35-gallon food grade drum made of non-conductive plastic and connected to a DC power supply. The drum was filled with municipal tap water and treated with the electrolytic cell for 20 minutes. The treated water was then transferred to a standard foliar spray unit commonly used to apply pesticides to plants.

Treatment of the water did not change the pH of the water. However, the dissolved oxygen (DO) increased by 2 PPM and the Oxygen Reduction Potential (ORP) was negative −250 mv to −400 mv. Treatment of the water generated Reactive Oxygen Species (ROS) in the water, including 2.0 PPM of hydrogen peroxide (H₂O₂), Oozone (O³) and hydroxides (—OH). Other than the temporary use of a 5% solution of acetic acid, the ROS in the treated water was the only pesticide used during the growing process.

Young tomato seedlings were sprayed with treated water twice a week for about four months. The irrigation system for the tomato plants was not altered nor was the fertilizer feed initially modified. The only change to farming process was spraying the plants with treated water twice a week. As a prophylactic measure, 5% bamboo vinegar was added to the treated water during the hot period of June through July, to prevent common mold and fungi ubiquitous at that time. Also, as the experiment continued, fertilizer levels were adjusted downward.

Results: Throughout the experiment, which lasted until July of 2022, an absence of mold, aphids, early and late fungi blight, and powdery mildew was observed. The tomato plants remained free from all types of infestations. Tomatoes from the plants were harvested 7 days early, as measured by attaining a 13% BRIX level and a 30% increase in yield was reported.

### Example 3

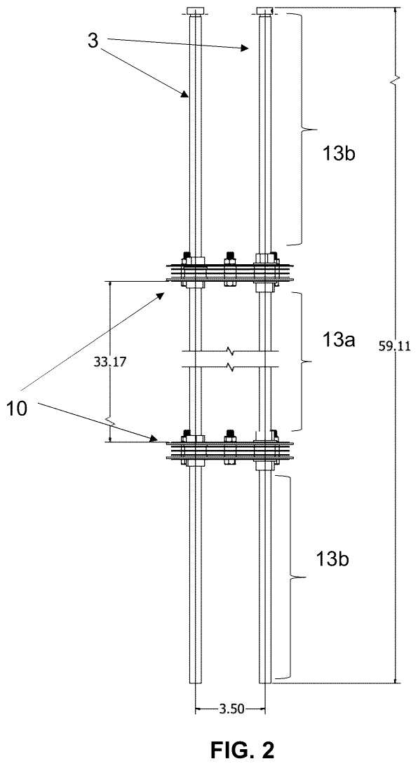

Percolation testing was carried out at Memphis Agricenter International, under the supervision of Dr. Bruce Kirksey. A perc-test measures a soil's moisture absorption rate. Specifically, a perc-test determines how long it takes for the soil to drain moisture added to the ground. Testing was carried out to determine whether water treated according to the instant disclosure (HHO water) differs with respect to its ability to penetrate soil. Improved ability to penetrate soil is useful for preventing water dissipation in drought-ridden areas. Dr. Louie Lin, Christian Brothers University and Dr. Kirksey of Agricenter International oversaw the testing. Both municipal tap water and well water were treated with an aerator like the one depicted in FIG. 2, having two stacks of 5 alternating cathodic mesh plates and anodic mesh plates sharing a common conductive titanium cathode rod and a conductive titanium anode rod. The aerator connected to a DC power supply was submerged into a 35-gallon food grade drum made of non-conductive plastic filled with the well water or the municipal tap water. Both the well water and the municipal tap were treated and tested. Shortly after treatment (within 1 hour of treatment) percolation testing was performed on packed yard soil, un-tilled field soil, and regular soil that was tilled but not packed. The results are presented in the table below.

Water Percolation Testing
(Distance in centimeters after 60 minutes)

| | Yard Soil | Un-tilled | Regular | Average |
|---|---|---|---|---|
| | (Packed) | Soil | Soil | % Increase |
| Well Water | 2.13 cm | 1.97 cm | 2.67 cm | |
| Treated well | 3.23 cm | 3.23 cm | 3.47 cm | |
| water | | | | |
| % Increase | 51.62% | 63.95% | 29.96% | +48.51% |
| Municipal Water | 2.43 cm | 1.57 cm | 2.4 cm | |
| Treated city water | 2.8 cm | 3.57 cm | 2.47 cm | |
| % Increase | 15.22% | 127.39% | 2.90% | +47.55% |

The data show that treated water (HHO water) penetrates deeper into all types of soil compared to untreated water. Thus, water treated according to the instant disclosure can be used to hydrate fallow land prior to planting. The dissolved oxygen (DO) and biochemical oxygen demand BOD remediation aspects are useful for treating soil polluted by urea and build-up of nitrogen and phosphate from fertilizers. Solar panels can be used to power the electrolytic cells in areas far away from a power source, for example, within vineyards and olive, almond, and avocado tree groves. Electrolytic cells can be included within a tote and mounted onto a tractor. As the water is treated, it can be sprayed to pre-treat soil. Also, water can be treated as it is dispersed into an irrigation system, as the treated water has a lifespan of about 10 hours as measured by oxygen reduction potential (ORP).

### Example 4

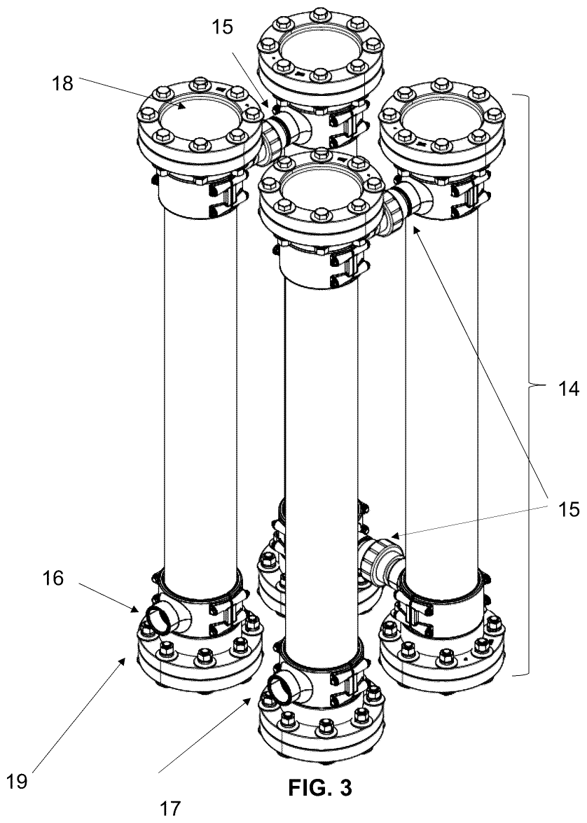

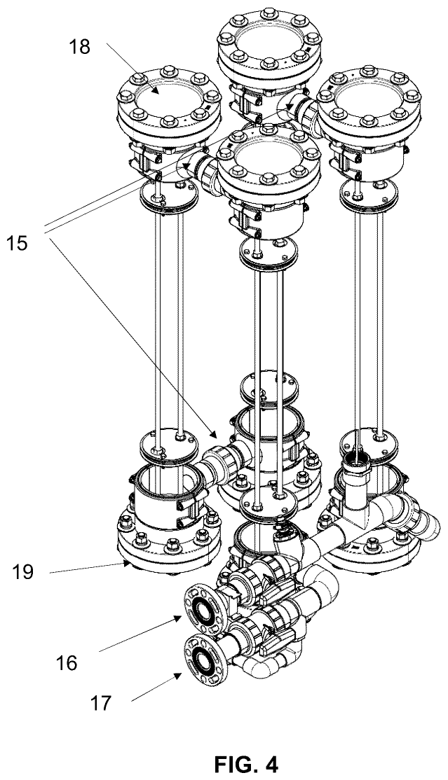

Field testing was carried out in rice patties by Memphis Agricenter International, under the supervision of Dr. Bruce Kirksey. The testing evaluated whether treated water (HHO water) influences crop yield. An area of land was divided into six equal parcels and three of the six parcels were randomly selected for growing rice (test parcels) with treated water (HHO water) and three of the parcels were used as controls using untreated well water. Water was treated with reactors like the one depicted in FIG. 3, which were powered by DC power source (12 volt) or treated with an aerator like the one depicted in FIG. 4, which was powered by 100-Watt solar panels. The well water treated with the series of reactors was used on two of the three test parcels and water treated with the aerator was used on one of the three test parcels. The control parcels and the test parcels were provided the same amount of water throughout the testing period. However, the test parcels were provided with treated water (aerated water) with the series of reactors. A summary of the results is presented in FIG. 7.

The treated water contained a substantial amount of hydrogen peroxide and ozone. The treated water also exhibited a lowered negative oxygen reduction potential (ORP) indicative of hydroxides (—OH). Hydrogen peroxide in the treated water is particularly beneficial for killing unwanted mold and pests. Therefore, treating the water with a series of reactors or an aerator is beneficial because it removes or destroys organic pollutants and pathogens prior to using the water on plants.

The results of the testing showed an increase of 11.2 additional bushels of rice per acre (bu/A), which is an increase in yield of 13.6%.

### Example 5

Several tests were conducted in Japan to determine how water treated according to the instant disclosure influences hydroponics. In hydroponics-to-open field scenarios, the seedlings are first incubated in a hydroponic setting and subsequently planted in soil. In an entirely hydroponic scenarios, the entire life cycle of the plant occurs indoors, hydroponically. Control plants were provided with municipal water and test plants were treated with HHO water.

The table below identifies the plants tested, the types of tests carried out, and the results of the testing.

| TESTING | RESULT | DURATION | TYPE OF TEST | BENEFITS | ADMINISTRATOR |
|---|---|---|---|---|---|
| POTATO | +85% | 95 days vs | Hydro to open | Faster to | Akagi-Japan |
| | | 102 days | field | harvest | |
| CARROT | +30% | 90 days vs 95 | Hydro to open | Faster to | Akagi Japan |
| | | days | field | harvest | |
| SOYBEANS | +60% | 87 days vs 94 | Hydro to open | Faster to | Akagi Japan |
| | | days | field | harvest | |
| CABBAGE | +57% | 65 days vs 72 | Hydro to open | Faster to | Akagi Japan |
| | | days | field | harvest | |
| SPINACH | +67% | 35 days vs 55 | Hydro to open | Faster to | Akagi Japan |
| | | days | field | harvest | |
| CANNABIS | +30% | 59 days | Hydro to open | −25% fertilizer | Phoenix Bio- |
| | | | field | | Sciences |

Another example from Japan compared the hydroponic growth of Komatsuna using water treated according to the instant disclosure and untreated tap water. Komatsuna, knows as Japanese mustard spinach, is a leaffy vegetable (Brassica Rapa) of the same species as the turnip, mizuna, napa cabbage, and rapini. The improvement in stem length, root length, and weight are shown in the table below.

| Komatsuna | Tap Water | HHO | Difference |
|---|---|---|---|
| Stem length | 9.4 cm | 18.3 cm | +64.25% |
| Root length | 11 cm | 17 cm | +43% |
| Weight | 4.1 cm | 11.3 g | +93.05% |

### Example 6

A study was carried out to evaluate the efficacy of water treating according to the instant disclosure (HHO water) in neutralizing nitrogen compound pollutants. Reverse osmosis treated water with a Total Kjeldahl Nitrogen (TKN) was used in the testing. The sum of nitrogen bound in organic substances (such as nitrogen in ammonia (NH₃) and in ammonium (NH₄+)) in the reverse osmosis treated water was 35 ppm. A single reactor like one of the four reactors shown in FIG. 3 was powered by a 100-Watt DC converter. Samples of water were treated with the single reactor and samples of the water were drawn at timed intervals to determine the time to reduce the TKN to ND or to 0 ppm. Testing showed that about 4 minutes was required to reduce TKN to ND or 0 ppm.

To expedite the reduction of TKN a series of reactors, like shown in FIG. 3, can be used. A series of sequentially aligned reactors increase total transit time of the water and ensures the water contacts stacks of cathodic mesh plates and anodic mesh plates for longer periods. Using a series of reactors allows for fast reduction of TKN and reduction or neutralization of other complex organic compounds such as polyfluoroalkyl substances or PFAS, polycyclic aromatic hydrocarbons (PAHs), manganese, and organic arsenic. The series of reactors is also useful for treating water contaminated with laundry detergents, textile industry waste, soaps, protein contamination or other food processing industry waste, slaughterhouse waste, cannery waste, resins, for example, resins produced by the paint manufacturing industry, agrochemicals waste, agricultural runoff, phosphates, and pathogens such a bacteria, viruses and anaerobic bacteria, and other biochemical oxygen demand compounds (BOD

### Example 7

In remote villages, refugee camps, medical centers, or natural disaster zones where water is contaminated with hydrocarbons or other organic material, water can be drawn, filtered through a sand filter, and drafted into a jug, vessel, or container. One or more electrolytic cells like shown in FIG. 1 and FIG. 2 can be connected to a solar panel to power the electrolytic cells. Water would be cleaned of organic contaminants during daylight hours. Depending on the level of pollutants, water could be potable after only about ten to twenty minutes. This inexpensive solution for clean water does not rely on conventional infrastructure for power as solar panels, even used ones, with direct connections and without inverters can be used to power the electrolytic cells and to increase DO while lowering BOD. The continual process of generating these hydroxide and Reactive Oxygen Species (ROS) gases decontaminates even the most complex organic contaminants and bacteria given sufficient time.

### Example 8

The reactors of the instant disclosure can be used to produce hypochlorite. A Hayward CL200 In-line Automatic Chemical Feeder, which is typically used for chlorine tablet contact with pool water, was employed. Salt (NaCl) was added to the water flowing through the low-pressure zone within the chemical injector providing a controllable amount of brine to mix with the overall water flow. The briny water is treated with a reactor according to the instant disclosure the resulting catalytic reaction dissociates the water and also dissociates NaCl. NaCl₍ₛ₎+H₂O₍ₗ₎=Na⁺₍ₛ₎+Cl⁻₍ₗ₎+H₂O₍ₗ₎ The energy needed to produce HHO and chlorine was less than 3.0 A/cm²@1.6 V, as the briny water acted as a conductor (SI), thus lowering resistance. The reactors allow for generation of hypochlorite or ClO⁻ with minimal solar power using tap-water or irrigation water and salt. The ability to produce ClO⁻ on demand in an outdoor environment has application to lagoons, whether from livestock or human waste, smell abatement, disinfection of livestock holding pens, chicken coops or pork sties to prevent or combat viruses or invasive pathogens. The strength of the ClO⁻ concentration is adjustable by slowing the flow (time to contact) or by increasing the amount of dissolved NaCL or brine. There are many uses for in-situ ClO⁻ ranging from deployable disinfection units in disaster zones, mosquito abatement programs by spraying still waters, surface pollutants and industrial high pressure spraying feedstock.

### Example 9

Algae is commonly harvested using centrifuges which spin the algae out of solution. However, electrolytic cells and reactors according to the instant disclosure can be used with variable DC voltage and current controls, in salt water populated with Nannochloropsis, a marine-water, single-celled algae. With a minimum of 1-3 volts and 5-7 amps, the algae is gently flocculated without generating excess chlorine, which could bleach the algae. This method of flocculating algae for mechanical skimming at the surface and bag filtering is an inexpensive method for utilizing algae as a potential energy source, fertilizer, and food source. As the algae is harvested, it retains its properties such as lipid and carbohydrates content without the odor typically associated with centrifuged degrading algae. The recovered algae ban be transported with ease from warm weather countries, such as Spain, to Northern climates where algae is used to boost British thermal unit (BTU) content of methane or co-gen digesters. As a food source, principally for livestock, the minor salt content and palatable aroma of the freshly harvested algae increases the likeability factor for animals. As a fertilizer, the algae is useful to impart phosphate and nitrogen content to soil and the available ClO⁻ acts as a root-virus-disease antagonist. Furthermore, if electrolytic cells are used during the growth period in an outdoor raceway, for example, a series of strategically placed electrolytic cells or reactors using a very low current would increase growth, while reducing competitive species such as amoebas and prokaryotes.

### Example 10

An aerator according to the instant disclosure can be used during food manufacture, preparation, or transport. Foodborne illness is often caused by consuming food contaminated by bacteria and/or their toxins, parasites, viruses, chemicals, or other agents. The federal government estimates about 48 million cases of foodborne illness each year in the United States. This estimate is amounts to about 1 in 6 Americans becoming sick from contaminated food each year, which results in an estimated 128,000 hospitalizations and 3,000 deaths per year. Aerators according to the instant disclosure can be deployed at the harvest sites for contamination-prone green leafy vegetables. The HHO water can be doused on the vegetable prior to shipping, or the vegetables can be sprayed treated water having a slight ClO⁻ content while growing in the fields. In a commercial or home kitchen, a smaller diameter stack of 3 or five mesh plates can be placed into a sink and electrified with a battery pack or AC/DC converter. Vegetables can be rapidly washed to remove pathogens and organic pesticides and pesticide residues. This same concept can be applied to meats and seafood.

### Example 11

In balneology, or the art of bathing, there is apparent merit to bathing in HHO water. Thus, the electrolytic cells of the instant disclosure can be used to generate HHO for use in a spa, onsen, jacuzzi, pool, etc. The water is useful for cleaning both humans and animals (including pets) because water rich in ROS and hydroxides has deeper cleaning properties.

### Example 12

The electrolytic cells of the instant disclosure can be used in residential and industrial water systems. For example, the electrolytic cells can be implanted into a cartridge or housing and used to remove dangerous organic material prior to carbon or membrane filtration.

### Example 13

HHO gases have been used in intake manifolds of trucks or engines to optimize burn. See, e.g., US2013/0015077, which is incorporated herein by reference in its entirety. Ab electrolyte solution is used to create HHO gas, which is fed into the intake manifold of an engine. The electrolytic cells of the instant disclosure are not dependent on pH and can be adapted for use with combustion engines, for example, in trucks and cars. During preliminary testing with the electrolytic cells of the instant disclosure a 28% to 35% reduction in fuel consumption was observed. Use of the electrolytic cells results in fuels burning cleaner, thereby lowering carbon dioxide (CO₂) output.

### DETAILED DESCRIPTION OF THE FIGURES

FIG. 1 shows an electrolytic cell comprising a stack (10) of five alternating cathodic mesh plates (1) and anodic mesh plates (2) that are substantially parallel to one another and spaced apart from one another. A cathodic mesh plate (1) is positioned on each end (top and bottom) of the stack (10) and an internal cathodic mesh plate (1) is positioned in the center of the stack (10) between two anodic mesh plates (2). Conductive titanium rods (3) are shown running transversely through the stack (10) of five alternating cathodic mesh plates (1) and anodic mesh plates (2). One titanium rod (3) serves as a cathode and the other titanium rod (3) serves as an anode. The titanium rods (3) electrically connect the five alternating cathodic mesh plates (1) and anodic mesh plates (2).

The stack (10) of five alternating cathodic mesh plates (1) and anodic mesh plates (2) are held together with bolts (7), internal washers/spacers (9) and nuts (8). The bolts (7), like the conductive titanium rods (3), run transversely through the stack (10), the head of bolts (7) is on one end of the stack (10) and the nuts (8) securing the bolts (7) are on the opposite end of the stack (10). The internal washers/spacers (9) are positioned between each of the alternating cathodic mesh plates (1) and anodic mesh plates (2).

Conductive titanium rods (3) include lock nuts (4) positioned outside of each of the cathodic mesh plates (1) forming opposite ends (top and bottom) of the stack (10). The lock nuts (4) secure the stack (10) to the titanium rods (3).

The placement of the titanium rods (3) through the stack (10) of alternating mesh plates (1, 2) is unique in that the titanium rods (3) do not run through the center of the stack (11) of mesh plates (1, 2) nor do they run along the outer edge of the stack (11) of mesh plates (1, 2). The central surface area of the mesh plates (1, 2) is unencumbered and is available for contact with contaminated water. The titanium rods (3) are placed so they extend through the mesh plates (1, 2) in an area between the outer edge of the mesh plates (1, 2) and the center of the mesh plates (1, 2). This positioning of the titanium rods (3) is beneficial because it is drives electrical current directly throughout the titanium rods (3) and the entirety throughout the mesh plates (1, 2). Conductance is increased as resistance (0) is lowered due to increased contact between the plates and the conductive electrodes. Thus, Hydrogen-Hydrogen-Oxygen (HHO) gases are generated with low power usage and without requiring adjustments to pH or the use of additives, such as the industry standard, KOH.

In typical electrolysis practice, titanium or stainless-steel plates are connected to a power source by connectors positioned on the outer edges of metal plates or through the center of metal plates. The electrical current therefore runs from the outside edges of the metal plates inward, or from the center of the plates outward. With the electrolytic cell of the instant disclosure, the electric current flow is improved by positioning the titanium rods (3) through an interior area of the plates between the center of the plates and the outer perimeter of the plates. The electrical current is simultaneously extending inward from the titanium rods (3) to the center of the plates and outward from the titanium rods (3) to the outer edges of the plates. Further, surface area for electrolysis is increased by using the titanium rods themselves as a conductive cathodes and anodes that become part of the electrolyzing process.

Non-conductive separators/spacers (6) are shown between adjacent cathodic mesh plates (1) and anodic mesh plates (2). The non-conductive separators/spacers ensure the alternating cathodic mesh plates (1) and anodic mesh plates (2) are spaced apart from one another and are substantially parallel to one another. The non-conductive separators/spacers (6) are non-conductive to prevent shorting between plates. The non-conductive separators/spacers are sized to provide a space between adjacent cathodic mesh plates (1) and anodic mesh plates (2). The space between adjacent cathodic mesh plates (1) and anodic mesh plates (2) is about 2 to about 5 mm.

FIG. 1 shows holes cut out of the five alternating cathodic mesh plates (1) and anodic mesh plates (2) for receiving the titanium rods (3). Each mesh plate includes a larger hole (11) and smaller hole (12). The larger hole (11) prevent electrical connection because the perimeter of the hole is larger than the perimeter of the titanium rod (3) and therefore is not in direct contact with titanium rod (3). The smaller hole (12) is sized according to the perimeter of titanium rod (3) and is in direct contact with titanium rod (3) to ensure electrical conductivity between the titanium rod (3) and the mesh plate. Soldering can optionally be used, if desired, to enhance conductivity between the mesh plates and the titanium rod (3) running through the smaller hole (12) of the mesh plates, for example, using a flux that contains fluoride salts. The larger holes (11) and smaller holes (12) alternate along the mesh plates of the stack (10) so that the titanium rod serving as the cathode is electrically connected to each of the cathodic mesh plates (1) and the titanium rod serving as the anode is electrically connected to each of the anodic mesh plates (2). The electrolytic cell can be placed in contaminated water and DC voltage applied to the titanium rods (3). The electricity is propagated throughout the titanium rods and the entirety of the stack (10) of five alternating cathodic mesh plates (1) and anodic mesh plates (2), thereby generating Hydrogen-Hydrogen-Oxygen (HHO) gases.

FIG. 2 illustrates a combination of two electrically connected electrolytic cells. Each cell comprises a stack (10) of five alternating cathodic mesh plates (1) and anodic mesh plates (2), as shown in FIG. 1. However, the two electrolytic cells in FIG. 2 share the same two titanium rods (3) serving as the cathode and the anode for both cells. The same two titanium rods (3) run transversely through the two stacks (10) of five alternating cathodic mesh plates (1) and anodic mesh plates (2). The stacks (10) of the two electrically connected cells have an internal distance (13a) between them. The two titanium rods (3) run through the two stacks of plates (10) and extend beyond the two stacks of plates by an external distance (13b). The internal distance (13a) between two stacks (10) of mesh plates (1, 2) allows the contaminated water to gestate longer before subsequent treatment with a subsequent electrolytic cell. Allowing for longer gestation time allows for more contaminates in the contaminated water to be neutralized by Hydrogen-Hydrogen-Oxygen (HHO) gases generated during electrolysis. Hydrogen is produced by the titanium rod (3) serving as a cathode and by the cathodic mesh plates (1) and oxygen is produced by the titanium rod (3) serving as an anode and by the anodic mesh plates (2). FIG. 2 illustrates a combination of two electrically connected cells. However, more than two cells can be combined in a similar fashion along the length of the same two titanium rods (3).

FIG. 3 shows four housed reactors (14) connected in a series. Each housed reactor (14) contains one or more electrolytic cells (not shown). The electrolytic cells housed within the reactors (14) can be arranged, for example, as shown in FIG. 3. Each reactor (14) in the series has an inlet (16) and an outlet (17). The reactors (14) are connected in a series by reactor connectors (15) connecting the outlet (17) of one reactor to the inlet (16) of a subsequent reactor (14) in the series. The reactor connectors (15) ensure that the four reactors (14) are fluidly connected to one another. In FIG. 3, the housed reactors (14) are shown with a tubular housing capped at each end with a circular top casing (18) and a circular bottom casing (19). The first of the four reactors in the series has an inlet (16) for introducing contaminated water through the series and the fourth reactor in the series has an outlet for dispatching treated water. FIG. 3 shows a series of four reactors (14) but the number of reactors connected in a series is not limited to four reactors. Additional reactors (or fewer reactors) can be connected in a series.

FIG. 4 shows a series of four identical combinations of two electrically connected electrolytic cells, which can optionally be housed in the series of four reactors (14) of FIG. 3. However, the series of electrolytic cells shown in FIG. 4 can be constructed and used without the housing shown in FIG. 4, as an aerator and water purification device. FIG. 4 shows a series of four combination of two electrically connected electrolytic cells, like shown in FIG. 2. FIG. 4 also shows an inlet (16) and an outlet (17) and reactor connectors (15) used when the four combinations of two electrically connected electrolytic cells are housed reactors (14), as shown in FIG. 3. When used as an aerator, inlet (16), outlet (17), and reactor connectors (15) are not needed. The inlet (16) and the outlet (17) in FIG. 4 are positioned differently (closer together) than shown in FIG. 3. Nonetheless, the inlet (16) and outlet (17) function similarly by introducing contaminated water into the inlet (16) for treatment through the series, after which the treated water is dispensed through the outlet (17). FIG. 4 uses piping to provide convenient introduction of contaminated water and recovery of treated water.

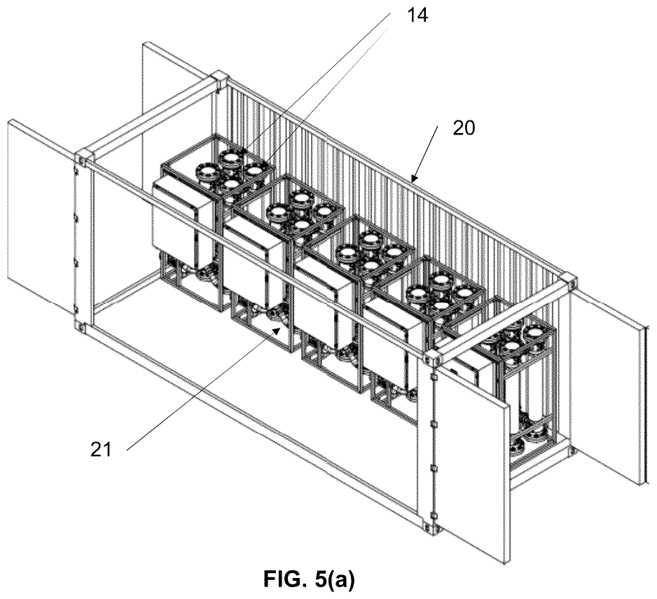

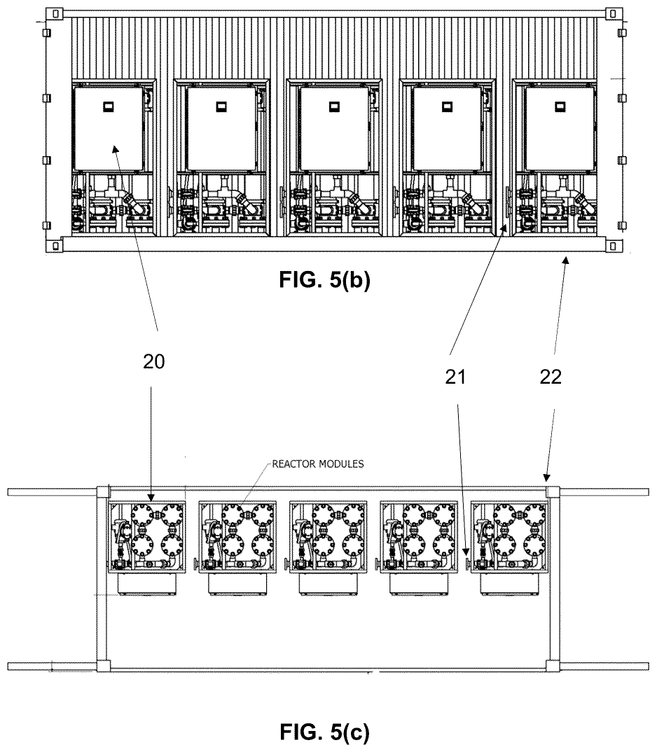

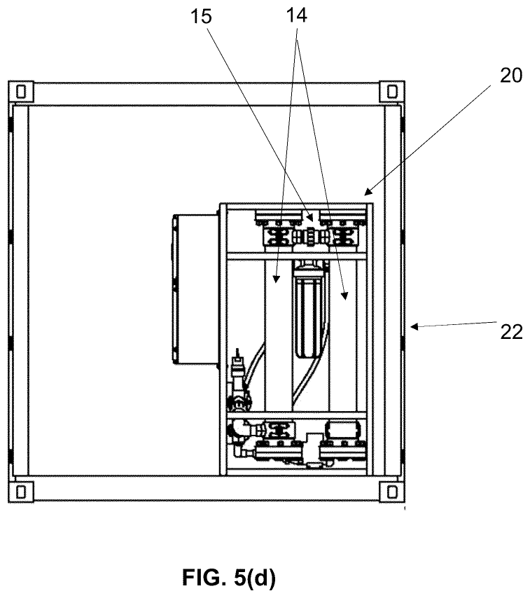

FIG. 5(a) is a perspective view of a tank (22) containing five modules (20) containing four housed reactors (14) connected in a series. Each module (20) can be connected to one another in a series with a module connector (21). When all five modules (20) in FIG. 5(a) are connected in a series, the contaminated water passes consecutively through twenty reactors (four in each of five modules). If the combination of FIG. 2 is used for each of the twenty reactors (14), the contaminated water passes through forty electrolytic cells, each containing a stack (10) of five alternating cathodic mesh plates (1) and anodic mesh plates (2), as shown in FIG. 1. Alternatively, each module may be independent from one another, i.e., contaminated water is not passed consecutively from one module to another module. Regardless of whether the modules are consecutively connected to one another, the series of reactors in each modules treat the contaminated water in the tank (22). After a sufficient period of time, the water in the tank (22) becomes decontaminated and removed from the tank (22). FIG. 5(b) is a front view of a tank (22) with five modules (20), each containing four housed reactors (14) (not shown). FIG. 5(b) shows where module connectors (21) may optionally be included in instances where connecting the modules in a series is desired. FIG. 5(c) is a top view of a tank (22) with five modules (20), each containing four housed reactors (14) connected in a series. FIG. 5(c) also shows where module connectors (21) may optionally be included in instances where connecting the modules in a series is desired. FIG. 5(d) is a side view of a tank (22) showing the side of one of five modules (20). Two of the four reactors (14) are shown connected by a reactor connector (15).

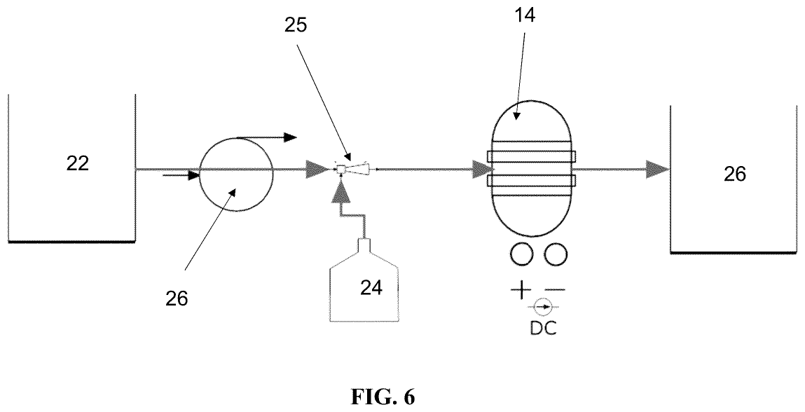

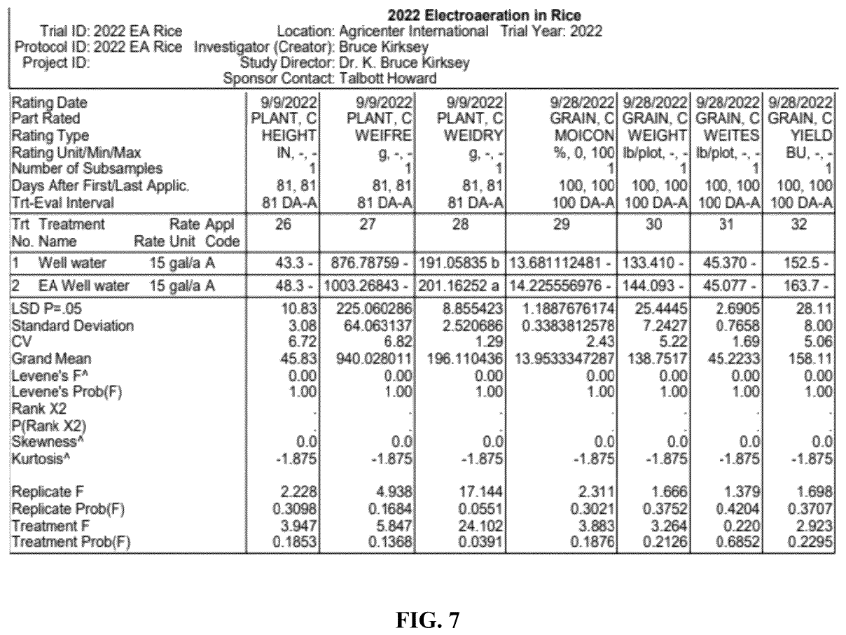

FIG. 6 is a diagram outlining an electro-catalytic water purification process using a reactor (14). Contaminated water (22) is pumped using pump (23) and combined with a brine solution (24) using a venturi injector. The contaminated water/brine mixture is fed into a reactor (14) and the treated water (26) is expelled and can be contained for use.

FIG. 7 shows the results of field testing on rice patties using water treated in accordance with the instant disclosure compared to control, as described in Example 4.

### Definitions

Key for Figures

| FIG. 1 | Electrolytic Cell |
|---|---|
| 1 | Anodic Mesh Plate |
| 2 | Cathodic Mesh Plate |
| 3 | Titanium Cathode Rod/Anode Rod |
| 4 | Lock Nut |
| 5 | Washer |
| 6 | Non-Conductive Separator/Spacer |
| 7 | Bolt |
| 8 | Nut |
| 9 | Internal Washer/Spacer |
| 10 | Stack of Plates |
| 11 | Larger Hole |
| 12 | Smaller Hole |
| FIG. 2 | A Combination of Two Electrically Connected Cells |
| 3 | Titanium Cathode Rod/Anode Rod |
| 10 | Stack of Plates |
| 13a | Internal Distance |
| 13b | External Distance |
| FIG. 3 | Four Housed Reactors Connected in a Series |
| 14 | Reactor |
| 15 | Reactor Connector |
| 16 | Reactor Inlet |
| 17 | Reactor Outlet |
| 18 | Top Casing of Reactor |
| 19 | Bottom Casing of Reactor |
| FIG. 4 | Four Interconnected Reactors without Housing |
| | (Aerator) |
| 3 | Titanium Cathode Rod/Anode Rod |
| 10 | Stack of Plates |
| 15 | Reactor Connector |
| 16 | Reactor Inlet |
| 17 | Reactor Outlet |
| 18 | Top Casing of Reactor |
| 19 | Bottom Casing of Reactor |
| FIG. 5 | Tank and Modules Containing Four Interconnected |
| | Reactors |
| FIG. 5(a) | Perspective View of Five Modules in a Container |
| 14 | Reactor |
| 20 | Module |
| 21 | Module Connector |
| 22 | Tank |
| FIG. 5(b) | Front View of Modules in a Container |
| 20 | Module |
| 21 | Module Connector |
| 22 | Tank |
| FIG. 5(c) | Top View of Five Modules |
| 14 | Reactor |
| 15 | Reactor Connector |
| 20 | Module |
| 21 | Module Connector |
| 22 | Tank |
| FIG. 5(d) | Side View of Individual Module |
| 14 | Reactor |
| 15 | Reactor Connector |
| 20 | Module |
| 21 | Tank |
| FIG. 6 | Electro-Catalytic Purification Process |
| 14 | Reactor |
| 22 | Contaminated Water |
| 23 | Pump |
| 24 | Brine Solution |
| 25 | Venturi Injector |
| 26 | Decontaminated Water |

The terms “a,” “an,” and “the” are understood to encompass the plural as well as the singular.

A “washer” is a relatively thin plate (typically disk-shaped, but sometimes square or other shapes) with a hole, typically in the middle, that is useful for distributing a load of a threaded fastener, such as a bolt or nut.

A “bolt” is a form of threaded fastener with an external male thread requiring a matching pre-formed female thread such as a nut. Bolts are very closely related to screws and for purposes of the instant disclosure bolts differ from screw by requiring a nut. A “screw” is a type of hardware fastener attributing its mechanical capabilities to a helical groove that extends around the circumference of the device's shank. These threads provide the friction and traction that serves a screw's purpose to assemble or position two workpieces in relation to each other.

A “rod” is a slender bar, like a stick, wand, or staff. The shape of the rod is not limited and can be square, rectangular, round, oval, octagonal, triangular, etc.

A “plate” is a thin, flat, object which can be in the shape of a round or oval shape but is certainly not limited to round or oval shapes. The shape of a plate is not limited. Therefore, a plate can be round, oval, square, rectangular, octagonal, triangular, etc.

“Circularly shaped” is intended to denote a round shape but does not require exactness. For example, a circularly shaped plate can be round, but can also be oval shaped.

The term “oxygen reduction potential” can be represented by “ORP.”

The term “biochemical oxygen demand” can be represented by “BOD.”

The term “dissolved oxygen” can be represented by “DO.”

The term “hydrogen and oxygen gases” can be represented by “HHO.”

The term “hydrogen-hydrogen-oxygen,” can be represented by “HHO.”

The term “total suspended solids” can be represented by “TSS.”

The term “biochemical oxygen demand” can be represented by “BOD.”

The term “chemical oxygen demand” can be represented by “COD.”

The term “Kjeldahl nitrogen” can be represented by “TKN.”

The expression “one or more” means “at least one” and thus includes individual components as well as mixtures/combinations.

The term “plurality” means “more than one” or “two or more.”

Other than in the operating examples, or where otherwise indicated, all numbers expressing quantities of ingredients and/or reaction conditions can be modified in all instances by the term “about,” meaning within +/−5% of the indicated number.

All ranges and values disclosed herein are inclusive and combinable. For examples, any value or point described herein that falls within a range described herein can serve as a minimum or maximum value to derive a sub-range, etc. Furthermore, all ranges provided are meant to include every specific range within, and combination of sub-ranges between, the given ranges. Thus, a range from 1-5, includes specifically 1, 2, 3, 4 and 5, as well as sub ranges such as 2-5, 3-5, 2-3, 2-4, 1-4, etc.

All components positively set forth in the instant disclosure can be negatively excluded. In other words, the cleansing compositions of the instant disclosure may be free or essentially free of any one or more of the components positively set forth in the instant disclosure.

The term “substantially free” or “essentially free” as used herein means the specific material may be present in small amounts that do not materially affect the basic and novel characteristics of the claimed invention. For instance, there may be less than 1% by weight of a specific material added to a composition, based on the total weight of the compositions (provided that an amount of less than 1% by weight does not materially affect the basic and novel characteristics of the claimed invention). Similarly, when a composition is essentially free from a particular element, the composition may include less than 1 wt. %, less than 0.5 wt. %, less than 0.1 wt. %, less than 0.05 wt. %, or less than 0.01 wt. %, or none of the specified material. Furthermore, all components that are positively set forth in the instant disclosure may be essentially excluded from the claims, e.g., a claimed composition may be “free,” “essentially free” (or “substantially free”) of one or more components that are positively set forth in the instant disclosure.

All publications and patent applications cited in this specification are herein incorporated by reference, and for any and all purposes, as if each individual publication or patent application were specifically and individually indicated to be incorporated by reference. In the event of an inconsistency between the present disclosure and any publications or patent application incorporated herein by reference, the present disclosure controls.

The instant disclosure illustrates and describes embodiments of the invention. The disclosure shows and describes only the preferred embodiments, but it is understood that the invention is useable in various other combinations, modifications, and environments and is capable of changes or modifications within the scope of the inventive concepts as expressed herein, commensurate with the above teachings and/or the skill or knowledge of the relevant art. The embodiments described herein above are further intended to explain best modes known by applicant and to enable others skilled in the art to utilize the disclosure. Accordingly, the description is not intended to limit the invention.

1. An energy efficient electrolytic cell comprising:
(a) a stack of 3 to 11 alternating cathodic mesh plates and anodic mesh plates stacked one upon another, each of the alternating cathodic mesh plates and anodic mesh plates having an outer perimeter, a center, and a face; wherein the alternating cathodic mesh plates and anodic mesh plates face one another, are substantially parallel to one another, and are spaced apart from one another by a separation space; and
(b) a conductive titanium cathode rod and a conductive titanium anode rod separately extending through each face of the cathodic mesh plates and each face of the anodic mesh plates, wherein the conductive titanium cathode rod and the conductive titanium anode rod extend through the face in an area between the outer perimeter and the center of each of the cathodic mesh plates and each of the anodic mesh plates, and
wherein a DC power source can be applied to the conductive titanium cathode rod and the conductive titanium anode rod to operate the electrolytic cell and carry out electrolysis.

2. The electrolytic cell of claim 1, wherein the anodic mesh plates are titanium mesh plates electrostatically coated with iridium oxide, platinum oxide, ruthenium oxide, or a combination thereof; and the cathodic mesh plates are uncoated titanium.

3. The electrolytic cell of claim 1, wherein the first (bottom) mesh plate of the stack and the last (top) mesh plate of the stack are cathodic mesh plates such that each anodic mesh plate in the stack is sandwiched between two cathodic mesh plates of the stack or the separation space between the alternating cathodic mesh plates and anodic mesh plates is about 2 to about 100 mm.

4. (canceled)

5. The electrolytic cell of claim 1, wherein
the titanium cathode rod directly contacts and electrically connects to each of the cathodic mesh plates but is not in direct contact and does not directly electrically connect to the anodic mesh plates, and
the titanium anode rod directly contacts and electrically connects to each of the anodic mesh plates but is not in direct contact and does not directly electrically connect to the cathodic mesh plates.

6. The electrolytic cell of claim 1, wherein the conductive titanium cathode rod runs through an area in one side of the faces of the alternating cathodic mesh plates and anodic mesh plates and the conductive titanium anode rod runs through an area in the opposite side of the faces of the alternating cathodic mesh plates and anodic mesh plates.

7. The electrolytic cell of claim 1, further comprising:
(c) a non-conductive spacer forming the separation space between adjacent faces of the alternating cathodic mesh plates and anodic mesh plates.

8. The electrolytic cell of claim 7, wherein the spacer is positioned between adjacent faces of the alternating cathodic mesh plates and anodic mesh plates and fitted around the conductive titanium cathode rod and fitted around the conductive titanium anode rod, to prevent a short circuit between adjacent faces of the alternating cathodic mesh plates and anodic mesh plates, wherein the spacer is shaped like a washer, wherein a hole in the spacer corresponds to the outer circumference of the conductive titanium cathode rod and the outer circumference of the conductive titanium anode rod, and wherein the spacer extends radially outward from the hole by about 1 mm to about 10 mm and has a height substantially identical to the separation space between adjacent faces of a cathodic mesh plate and an anodic mesh plate.

9. (canceled)

10. The electrolytic cell of claim 1, further comprising:
(d) one or more bolts running through the stack of alternating cathodic mesh plates and anodic mesh plates, wherein the head of the one or more bolts is positioned outside the exterior face of a terminal cathodic mesh plate at one end (bottom) of the stack and runs through the stack extending beyond the exterior face of the terminal cathodic mesh plate at the opposite end (top) of the stack; and
(e) one or more nuts attached to the extending end of the one or more bolts, thereby securing the stack of alternating cathodic mesh plates and anodic mesh plates together.

11. A combination of two or more electrolytic cells of claim 1 connected in a series, wherein the two or more electrolytic cells share the same conductive titanium cathode rod and the same conductive titanium anode rod.

12. The combination of the claim 11, wherein the stacks of each of the two or more electrolytic cells are separated from one another by an internal distance of about 50 to about 200 cm and/or the shared conductive titanium cathode rod and the shared conductive titanium anode rod extend beyond the last stack of mesh plates on each end of the series by an external distance of about 50 to about 200 cm.

13. An electrolytic aerator comprising one or more combinations of claim 11.

14. An electrolytic reactor comprising one or more combinations of claim 11, wherein the one or more combinations is encased in a housing.

15. The electrolytic reactor of claim 14, wherein the housing has an inlet for introducing contaminated water and an outlet for dispensing treated water, wherein the inlet directs the contaminated water into one end of the reactor for flow through the mesh plates of the one or more electrolytic cells and the outlet dispenses water after being run through the mesh plates of the one or more electrolytic cells of the reactor.

16. The electrolytic reactor of claim 15, wherein the housing comprises a tube-shaped component and further comprises a top casing on one end of the tube shaped housing component and a bottom casing on the other end of the tube-shaped housing component.

17. A series comprising two or more reactors of claim 15, wherein the two or more reactors are electrically connected to each other and are sequentially and fluidly connected to each other such that the outlet of a first reactor in the series is fluidly connected to the inlet of second reactor in the series, and the outlet of the second reactor in the series is optionally connect to the inlet of an additional reactor, if present, and the sequential connection of additional reactors, if present, continues until a desired number of reactors are sequentially connected in the series, wherein the terminal reactor of the series has an outlet for dispensing water treated by the series of reactors.

18. A module comprising a series of two or more reactors, wherein the module houses the series of two or more reactors of claim 17 but has an open top.

19. A series of two or more modules of claim 18, wherein each of the two or more modules are fluidly connected to one another such that contaminated water to be treated with the two or more modules is treated first by the first module before being introduced into the second module and treated with the second module, followed by sequential introduction and treatment with additional modules, if present.

20. An electrolytic reactor comprising:
(i) two or more electrolytic cells comprising:
(a) a stack of 3 to 11 of similarly sized alternating cathodic mesh plates and anodic mesh plates stacked one upon another, each of the alternating cathodic mesh plates and anodic mesh plates having an outer perimeter, a center, and a face,
wherein the alternating cathodic mesh plates and anodic mesh plates face one another, are substantially parallel to one another, and are spaced apart from one another by a separation space of about 2 mm to about 100 mm,
wherein the first mesh plate of the stack and the last mesh plate of the stack are cathodic mesh plates such that each anodic mesh plate in the stack is sandwiched between two cathodic mesh plates of the stack, and
wherein the anodic mesh plates are titanium mesh plates electrostatically coated with iridium oxide, platinum oxide, ruthenium oxide, or a combination thereof, and the cathodic mesh plates are uncoated titanium; and
(b) a conductive titanium cathode rod and a conductive titanium anode rod separately extending through each of the cathodic mesh plates and each of the anodic mesh plates, wherein the conductive titanium cathode rod and the conductive titanium anode rod extend through the face in an area between the outer perimeter and the center of each of the cathodic mesh plates and each of the anodic mesh plates,
wherein the titanium cathode rod directly contacts and electrically connects to each of the cathodic mesh plates but is not in direct contact and does not directly electrically connect to the anodic mesh plates, and
the titanium anode rod directly contacts and electrically connects to each of the anodic mesh plates but is not in direct contact and does not directly electrically connect to the cathodic mesh plates;
(c) non-conductive spacers forming the separation space between adjacent faces of the alternating cathodic mesh plates and anodic mesh plates,
wherein the spacers are positioned between adjacent faces of the alternating cathodic mesh plates and anodic mesh plates and fitted around the conductive titanium cathode rod or fitted around the conductive titanium anode rod, to prevent a short circuit between adjacent faces of the alternating cathodic mesh plates and anodic mesh plates;
(d) one or more bolts running through the stack of alternating cathodic mesh plates and anodic mesh plates, wherein the head of the one or more bolts is positioned outside the exterior face of a terminal cathodic mesh plate at one end (bottom) of the stack and runs through the stack extending beyond the exterior face of the terminal cathodic mesh plate (top) of the stack; and
(e) one or more nuts attached to the extending end of the one or more bolts, thereby securing the stack of alternating cathodic mesh plates and anodic mesh plates together;
(ii) housing encasing the two or more electrolytic cells;
(iii) an inlet for introducing contaminated water into the electrolytic reactor for treatment through the two or more electrolytic cells; and
(iv) an outlet for dispensing water from the electrolytic reactor that has been treated with the two or more electrolytic cells in the reactor.

21. The electrolytic reactor of claim 20, wherein the conductive titanium cathode rod runs through an area in one side of the faces of the alternating cathodic mesh plates and anodic mesh plates and the conductive titanium anode rod runs through an area in the opposite side of the faces of the alternating cathodic mesh plates and anodic mesh plates.

22. A process for treating water comprising:
(a) feeding water to be treated through an electrolytic cell of claim 1;
(b) applying a power source to the electrolytic call;
(c) generating treated water having H₂ and O₂ gases therein, in amounts higher than present in the water before being feed through the electrolytic cell; and
(d) watering the plants with the treated water.

23. (canceled)
